(19) United States
(12) Patent Application Publication
(10) Pub. No.: US 2003/0133429 A1
(43) Pub. Date: Jul. 17, 2003

(54) Uplink synchronization method in a CDMA communication system employing USTS

(75) Inventors: Sung-Ho Choi, Songnam-shi (KR); Hyun-Woo Lee, Suwon-shi (KR); Yong-Jun Kwak, Yongin-shi (KR); Joon-Goo Park, Seoul (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., KYUNGKI-DO (KR)

(21) Appl. No.: 10/135,092

(22) Filed: Apr. 29, 2002

(30) Foreign Application Priority Data
Apr. 27, 2001 (KR) P2001-23066

(51) Int. Cl. H04B 7/216

(52) U.S. Cl. 370/342; 370/441

(57) ABSTRACT

A method for synchronizing a reception time point of a UL DPCH signal to a previously expected time point when the reception time point of the UL DPCH signal received from a UE is different from the previously expected time point by a Node B, wherein the Node B transmits a DL DPCH signal to the UE at a time point assigned to the UE on a basis of a reference time point of the Node B, and the DL DPCH signal includes a stream of TAB bits for uplink synchronization control. The method comprises measuring a difference between the reception time point of the UP DPCH signal and the expected time point; transmitting information for maintaining a transmission time of the UL DPCH signal previously transmitted by the UE to the UE using the TAB bits, when there is a difference between a lower limit value and an upper limit value, determined by the number of the TAB bits of the DL DPCH signal received by the UE; transmitting information for advancing a transmission time of the previously transmitted UL DPCH signal as much as a set unit determined by the number of the TAB bits using the TAB bits, when the difference is larger than or equal to the upper limit value; and transmitting information for delaying a transmission time of the previously transmitted UL DPCH signal as much as the set unit using the TAB bits, when the difference is less than the lower limit value.

### PRIORITY

This application claims priority to an application entitled “Uplink Synchronization Method in a CDMA Communication System Employing USTS” filed in the Korean Industrial Property Office on Apr. 27, 2001 and assigned Serial No. 2001-23066, the contents of each of which are hereby incorporated by reference.

### BACKGROUND OF THE INVENTION

1. Field of the Invention

The present invention relates generally to a CDMA (Code Division Multiple Access) communication system, and in particular, to a method for acquiring uplink synchronization in a CDMA communication system using an uplink synchronous transmission scheme (USTS).

2. Description of the Related Art

A CDMA mobile communication system is divided into a synchronous system and an asynchronous system. Such a CDMA communication system uses orthogonal codes to separate channels. Herein, a description of the invention will be made with reference to an asynchronous W-CDMA (Wideband-CDMA) communication system, also known as a UMTS (Universal Mobile Telecommunications System) communication system. However, the invention can be applied to other CDMA systems such as the CDMA-2000 system, as well as the W-CDMA system.

The W-CDMA communication system employs an uplink synchronous transmission scheme (USTS) in which a Node B communicates with a plurality of UEs (User Equipments) through radio links formed between them while maintaining an orthogonal property among the signals received from the respective UEs. For the USTS, the Node B transmits a control signal to the UEs so that the respective UEs can transmit their signals at a proper time maintaining the orthogonal property among the UEs. Upon receipt of the control signal, the UEs align a transmission time of the uplink signals.

FIG. 1 illustrates architecture of a conventional W-CDMA communication system. As illustrated, a radio network controller (RNC) controls a process for connecting the UE. Further, the RNC manages assignment of channel resources to the UEs connected to one or more Node Bs. The Node Bs and the RNC constitute a UTRAN (UMTS Terrestrial Radio Access Network).

When successfully connected to the Node B through the channel assigned by the RNC, the UE maintains communication using the assigned downlink or uplink dedicated physical channel (DPCH). The W-CDMA communication system employs an asynchronous system in which the UEs are not synchronized with the Node B. The RNC communicates with a plurality of UEs through the Node B. In this case, the UE scrambles its transmission data using a unique scrambling code and transmits the scrambled data as an uplink signal, so that the Node B can distinguish the uplink signals received from the respective UEs.

The scrambling code is classified into a long scrambling code and a short scrambling code. In the following description, the “scrambling code” will refer to the long scrambling code.

The scrambling code is created in the following process:

(Step 1) receiving 24 initial values n0,n1, . . . ,n23,

(Step 2) creating sequences x(i) and y(i), where i=0, . . . ,2²⁵−27,

x(0)=n0, x(1)=n1, x(2)=n2, . . . , x(23)=n23, x(24)=1

x(i+25)=x(i+3)+x(i) modulo 2, i=0, . . . ,2²⁵−27

y(0)=y(1)=y(2)=. . . =y(23)=y(24)=1

y(i+25)=y(i+3)+y(i+2)+y(i+2)+y(i) modulo 2, i=0, . . . , 2²⁵−27

(Step 3) creating a sequence z(i), where i=0, . . . ,2²⁵−2,

z(i)=x(i)+y(i) modulo 2, i=0, . . . ,2²⁵−2,

(Step 4) creating a Gold sequence Z(i), where i=0, . . . ,2²⁵−2,

Z(i)=1−2*z(i)

(Step 5) creating two real scrambling codes c1(i) and c2(i), where i=0, . . . ,2²⁵−2,

c1(i)=Z(i)

c2(i)=Z((i+16777232) modulo (2²⁵−1)),

(Step 6) creating a scrambling code C(i), where i=0, . . . ,2²⁵−2,

C(i) c1(i)*(1+j(−1)ⁱ*c2(2*└i/2┘)).

In (Step 6), └i/2┘ indicates the largest one of integers smaller than or equal to i/2.

In the W-CDMA communication system, one frame is comprised of 38,400 chips. Therefore, the scrambling code is used in a unit of 38,400 chips. That is, a scrambling code for one DPCH is C(i), where i=0,1, . . . ,38,399.

A single DPCH frame signal is scrambled using the scrambling codes C(0) to C(38399). The respective UEs create the scrambling codes using different initial values n0,n1,..,n23, and then, scramble the DPCH signals with the created scrambling codes before transmission. The Node B then descrambles the signals received from the UEs using the scrambling codes uniquely assigned to the respective UEs, thereby distinguishing the signals from the respective UEs.

The latest W-CDMA communication system uses OVSF (Orthogonal Variable Spreading Factor) codes for channel separation. In the downlink, the Node B can distinguish the downlink DPCH (DL DPCH) signals transmitted to the different UEs using the OVSF codes. The Node B spreads the DL DPCH signals using the OVSF codes uniquely assigned to the respective UEs, sums up the spread DL DPCH signals, scrambles the summed DL DPCH signal with its unique scrambling code, and then transmits the scrambled DL DPCH signal. The respective DPCHs may have different data rates. In the uplink, the UE spreads a DPDCH (Dedicated Physical Data CHannel) signal and a DPCCH (Dedicated Physical Control CHannel) signal constituting a DPCH signal, using different OVSF codes, and scrambles the spread DPDCH and DPCCH signals with its unique scrambling code before transmission. The OVSF codes used by the UE to spread the DPDCH and DPCCH signals may also be identical to each other. Since the UEs transmit the signals using the different scrambling codes, the Node B can distinguish the signals received from the respective UEs.

The UE employing the USTS scrambles the DPDCH signal and the DPCCH signal spread with the different OVSF codes using an uplink scrambling code commonly used by the UEs in a cell where it is located, instead of using its unique scrambling code, and transmits the scrambled signals. Further, the UE employing the USTS spreads DPDCH signal and the DPCCH signal with a unique OVSF code (i.e., a channelization code), assigned from the Node B, and transmits the spread signals. The Node B then despreads the signals received from the respective UEs using the OVSF codes uniquely assigned to the UEs, thereby distinguishing the received signals.

In addition, the W-CDMA communication system transmits the respective DL DPCH signals with different time offsets, in order to prevent the transmission power from increasing instantaneously when the Node B simultaneously transmits a plurality of downlink DPCH (DL DPCH) signals. By doing so, the uplink DPCH (UL DPCH) signals also arrive at the Node B at different points in time, preventing the Node B from simultaneously processing the signals received from a plurality of UEs, thereby distributing a load of the Node B.

FIG. 2 illustrates the timing relationship between the DL DPCH signal and the UL DPCH signal in the W-CDMA communication system, wherein it is assumed that there is no propagation delay between the Node B and the UEs, (i.e., that the UE receives the DL DPCH transmitted by the Node B with no propagation delay and the Node B also receives the UP DPCH transmitted by the UE with no propagation delay). When there is a propagation delay between the Node B and the UEs, a round trip time (RTT) must be considered. However, since the system will operate in the same manner even though there is the propagation delay, the round trip time will be assumed to be ‘0’.

Referring to FIG. 2, one 10 ms frame is comprised of 15 slots, and each slot is comprised of 2560 chips. A common pilot channel (CPICH) and a primary common control physical channel (P-CCPCH) are frame-synchronized with each other, and used as a reference time for other channels.

As illustrated in FIG. 2, the respective DL DPCHs are transmitted with a time offset τ_{DPCH,n} against the P-CCPCH. The respective DPCHs are given the different time offsets τ_{DPCH}. For example, each DPCH is given one of 0, 256, 2*256, . . . , 148*256 and 149*256-chip offsets. That is, the DPCH is given a time offset of a multiple of 256 chips against the reference time.

The UE transmits the UL DPCH signal after a lapse of time Tₒ after receiving the DL DPCH signal with a time offset τ_{DPCH,n} against the P-CCPCH. Therefore, the UL DPCH signals also have different transmission time points, so that the UL DPCH signals arrive at the Node B at the different time points. Due to a distance difference between the Node B and the respective UEs, the Node B may not receive the UL DPCH signal exactly after a lapse of the time Tₒ after transmitting the DL DPCH signal. Therefore, the Node B measures a propagation delay time to the UE in the process of transmitting a random access channel (RACH) signal in order to measure a distance from the UE, and uses this value in predicting an expected UL DPCH signal arrival time after transmission of the DL DPCH signal.

In the USTS mode, a plurality of UEs communicate with a Node B using the same scrambling code. The USTS is designed to synchronize the UL DPCH signals received at the Node B from a plurality of UEs. In the USTS mode, the Node B assigns the same scrambling code to the synchronized UEs. Therefore, the W-CDMA communication system employing the USTS reduces the number of scrambling codes used in the cell, contributing to a reduction in interference between UE signals. When the UEs employing the USTS use the same scrambling code, the Node B identifies the UEs using channelization codes, (i.e., the OVSF codes provided from the RNC). In the USTS mode, the Node B synchronizes the UL DPCH signals from at least 2 UEs with each other, and then assigns the same scrambling code to the synchronized UEs. Further, the Node B assigns the different channelization codes (or OVSF codes) to the UL DPCH signals of the UEs assigned the same scrambling code, to distinguish the received synchronized UL DPCH signals.

The USTS controls a sync time of the signal through the following two processes.

(1) Initial Synchronization Process

Upon receipt of a signal from a UE over the RACH, a Node B measures the difference between a predetermined reference time and an arrival time of the signal received over the RACH. The Node B transmits the measured time difference to the UE over a forward access channel (FACH). Upon receipt of the time difference over the FACH, the UE aligns its transmission time using the received time difference.

(2) Tracking Process

The Node B transmits a time alignment bit (TAB) to the UE by periodically comparing the arrival time of the UE signal and the reference time. If the TAB is ‘1’, the UE shifts the transmission time ahead by ⅛ chip. However, if the TAB is ‘0’, the UE shifts the transmission time behind by ⅛ chip. The TAB is transmitted once every two frames using a transmit power control (TPC) bit in the control channel.

In the USTS mode where several UEs use the same scrambling code, the uplink frame signals transmitted by the UEs using the same scrambling code must be synchronized with one another at the Node B. That is, when the Node B receives the DPCH signals transmitted from several UEs, the received DPCH signals must be subjected to both slot synchronization and frame synchronization. The frame synchronization minimizes interference among the UEs using the same scrambling code, while the slot synchronization distinguishes the UE signals from each other. The UEs perform spreading using the different OVSF codes and perform scrambling using the same scrambling code, depending on the orthogonal property of the OVSF codes. The Initial Synchronization Process is a process for acquiring the frame synchronization and the slot synchronization.

As described above, the respective DL DPCH signals have different time offsets τ_{DPCH,n}. Therefore, the UL DPCH signals received at the Node B are not synchronized (or misaligned) with one another. During the Initial Synchronization Process, the misalignment among the UL DPCH signals is removed to synchronize the UL DPCH signals. Accordingly, there is a demand for a method for resolving the channel misalignment problem in the Initial Synchronization Process.

As stated above, since the USTS synchronizes the uplink within one cell and uses the channelization codes and a specific scrambling code different from a normal DPCH not supporting the USTS service, a special handover method is required. That is, in the case of the normal DPCH, each UE uses a unique uplink scrambling code. However, in the case of the USTS, a plurality of the UEs share the same scrambling code. Further, in the case of the normal DPCH, a node position of an OVSF code for spreading the DPCCH signal is SF256 which is the highest position in the OVSF code tree. However, in the case of the USTS, the node position may be different. In addition, a node position of the OVSF code for spreading the DPDCH signal may also be different from the node position of the OVSF code in the OVSF code tree, used by the normal DPCH. However, in the case of the USTS, the UE performs special synchronization, so that when the handover is performed in the same method as done by the existing UMTS system, two or more connections operate differently. Therefore, it is not possible to perform a USTS handover using the existing handover method. Thus, there is a demand for a separate handover method.

In addition, there is a demand for a mode switching method for switching an operation mode of the UE to the USTS mode, when the UE, which supports the USTS service but operates in the normal mode or non-USTS mode, enters into coverage of the Node B supporting the USTS service.

### SUMMARY OF THE INVENTION

It is, therefore, an object of the present invention to provide a method for performing synchronization in a CDMA communication system employing the USTS.

It is another object of the present invention to provide a method for acquiring frame synchronization and slot synchronization of UL DPCH signals from UEs employing the USTS in a CDMA communication system.

It is further another object of the present invention to provide a method for performing a handover in a CDMA communication system employing the USTS.

It is yet another object of the present invention to provide a method for exchanging USTS messages for performing a UE handover between an RNC and a Node B in a CDMA communication system employing the USTS.

It is still another object of the present invention to provide a method for maintaining synchronization between a UE and a Node B during a handover of the UE employing the USTS in a CDMA communication system.

It is still another object of the present invention to provide a method for rapidly acquiring initial synchronization in a CDMA communication system employing the USTS.

It is still another object of the present invention to provide a method for rapidly acquiring synchronization by performing a plurality of tracking modes in a CDMA communication system supporting a USTS service.

It is still another object of the present invention to provide a tracking method for correcting a transmission error that occurs during synchronization in a CDMA communication system using the USTS.

It is still another object of the present invention to provide a tracking method for removing transmission time delay by performing transmission time-advancing control, transmission time-delaying control and transmission time-maintaining control on an uplink signal in a CDMA communication system employing the USTS.

To achieve the above and other objects, there is provided a method for synchronizing a reception time point of a downlink dedicated physical channel (UL DPCH) signal to a expected time point when the reception time point of the UL DPCH signal received from a UE is different from the expected time point by a Node B, wherein the Node B transmits a downlink dedicated physical channel (DL DPCH) signal to the UE at a time point assigned to the UE on a basis of a reference time point of the Node B, and the DL DPCH signal includes a stream of TAB bits for uplink synchronization control. The method comprises measuring a difference between the reception time point of the UP DPCH signal and the expected time point; transmitting information for maintaining a transmission time of the UL DPCH signal transmitted by the UE to the UE using the TAB bits, when there exists a difference between a lower limit value and an upper limit value, determined by the number of the TAB bits of the DL DPCH signal received by the UE; transmitting information for advancing a transmission time of the UL DPCH signal as much as a set unit determined by the number of the TAB bits using the TAB bits, when the difference is larger than or equal to the upper limit value; and transmitting information for delaying a transmission time of the UL DPCH signal as much as the set unit using the TAB bits, when the difference is less than the lower limit value.

To achieve the above and other objects, there is provided a method for controlling a transmission time point of a UL DPCH signal when a reception time point of the UL DPCH signal received from a UE is different from a expected time point, wherein a Node B transmits a DL DPCH signal to the UE at a time point assigned to the UE on a basis of a reference time point of the Node B, the DL DPCH signal includes a stream of TAB bits for uplink synchronization control, and each of the TAB bits has a first value for advancing the transmission time point of the UL DPCH signal in a preset unit and/or a second value for delaying the transmission time point of the UL DPCH signal in the preset unit by analyzing the reception time point of the UL DPCH signal received from the UE and transmission time delay. The method comprises receiving a stream of TAB bits of the DL DPCH, and advancing the transmission point of the UL DPCH signal in the preset unit when the number of the received TAB bits having the first value is larger than or equal to a first number; delaying the transmission time point of the UL DPCH signal when the number of the received TAB bits having the first value is less than a second number; and maintaining the transmission time point of the UL DPCH signal when the number of the received TAB bits having the first value is larger than or equal to the second number and less than the first number.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating architecture of a W-CDMA communication system;

FIG. 2 is a diagram illustrating a timing relationship between a DL DPCH and an UL DPCH in the W-CDMA communication system;

FIG. 3 is a diagram illustrating a timing relationship when synchronization is performed by a USTS according to an embodiment of the present invention;

FIG. 4 is a block diagram illustrating a structure of a scrambling code synchronization apparatus for a UE according to an embodiment of the present invention;

FIG. 5 is a diagram illustrating a structure of a UTRAN in a W-CDMA mobile communication system according to an embodiment of the present invention;

FIG. 6 is a diagram illustrating a structure of a UTRAN in a W-CDMA mobile communication system according to another embodiment of the present invention, wherein a handover of a UE is performed within a same Node B;

FIG. 7 is a diagram illustrating a structure of a UTRAN in a W-CDMA mobile communication system according to another embodiment of the present invention, wherein a handover of a UE is performed to another Node B within a same RNC;

FIG. 8 is a diagram illustrating a structure of a UTRAN in a W-CDMA mobile communication system according to another embodiment of the present invention, wherein a handover of a UE is performed to a cell within another RNC;

FIG. 9 is a flow diagram illustrating a process for transmitting a Radio Link Addition Request message to another cell in a same Node B during a USTS handover according to another embodiment of the present invention;

FIG. 10 is a flow diagram illustrating a process for transmitting a Radio Link Setup Request message to another Node B within a same RNC during a USTS handover according to another embodiment of the present invention;

FIG. 11 is a flow diagram illustrating a process for transmitting a Radio Link Setup Request message to a cell in another RNC during a USTS handover according to another embodiment of the present invention;

FIG. 12 is a flowchart illustrating an operation of a Serving RNC (SRNC) during a handover according to the present invention;

FIG. 13 is a flowchart illustrating an operation of an Node B in a new cell for a handover according to the present invention;

FIG. 14 is a flowchart illustrating an operation of an SRNC when a UE is transitioned to a USTS mode during communication on a DPCH according to the present invention;

FIG. 15 is a flowchart illustrating an operation of a Node B when a UE communicating on a DPCH transitions to a USTS mode according to the present invention;

FIG. 16 is a block diagram illustrating a structure of a scrambling code synchronizer in a Node B according to the present invention;

FIG. 17 illustrates an initial synchronization process performed by a Node B using a tracking process according to an embodiment of the present invention;

FIG. 18 illustrates an initial synchronization process performed by a UE using a tracking process according to an embodiment of the present invention;

FIGS. 19A to 19D illustrate a sliding window structure according to a first transmission time-robust control method;

FIGS. 20A to 20D illustrate a sliding window structure according to a second transmission time-robust control method;

FIG. 21 schematically illustrates transmission time delay in a mobile communication system performing a USTS service;

FIGS. 22A to 22D illustrate a sliding window structure according to a third transmission time-robust control method;

FIG. 23 illustrates a transmission time control process by a Node B according to the first transmission time-robust control method;

FIG. 24 illustrates a transmission time control process by a Node B according to the third transmission time-robust control method;

FIG. 25 illustrates a transmission time control process by a UE according to the first transmission time-robust control method; and

FIG. 26 illustrates a transmission time control process by a UE according to the second transmission time-robust control method.

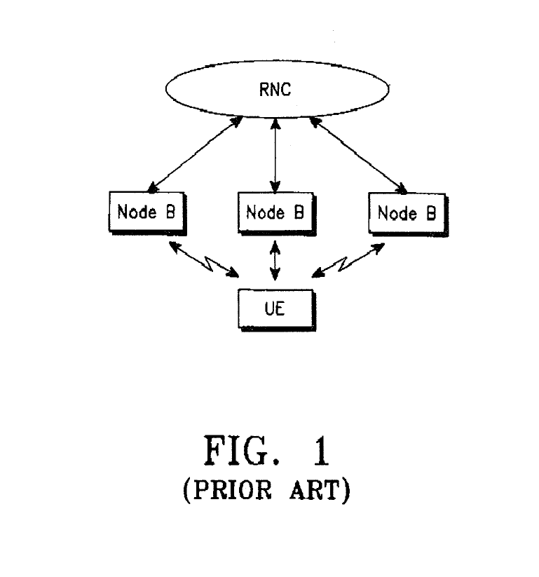

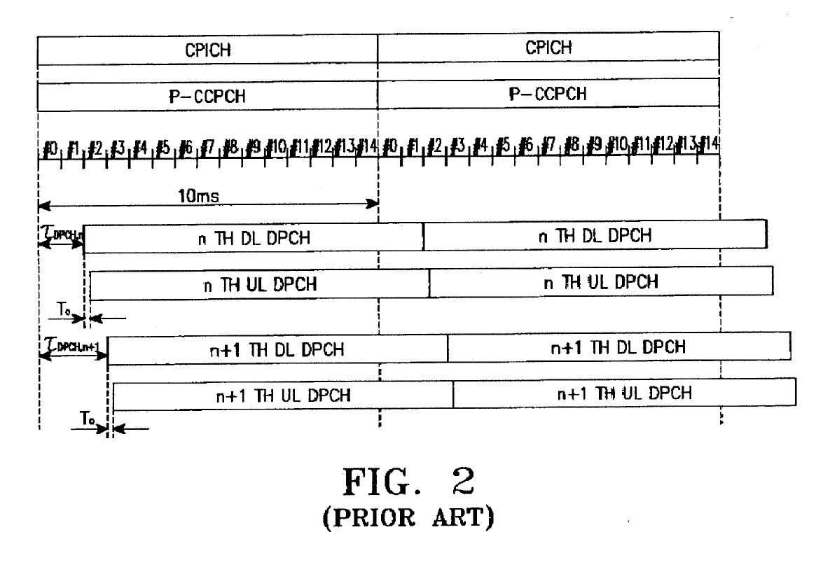

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

An embodiment of the present invention discloses a method for synchronizing UL DPCHs transmitted from UEs, which perform scrambling using the same scrambling code, in a CDMA communication system employing the USTS (Uplink Synchronous Transmission Scheme). A process necessary for initial synchronization of the UL DPCH can be divided into two processes: one is a process for synchronization in a slot unit or 256*m-chip unit, and another is a scrambling code synchronization process.

First, the slot or 256*m-chip unit synchronization process will be described. In the 256*m-chip unit synchronization process, a unit time may become a chip. For example, the unit time may be a (1/k) chip. In this case, the 256*m-chip unit synchronization is identical to the 256*m*k(1/k)-chip unit synchronization in structure, but different in the unit time. When the unit time is a (1/k) chip, all values are calculated in a (1/k)-chip unit. The k value is an integer. For example, if k=1, the unit time is a chip. Further, the k value may become 4 or 8. Although the invention will be described with reference to one case where a time unit of the 256*m-chip unit synchronization is a chip (i.e., k=1), the invention can also be applied to other cases where the time unit is a (1/k) chip.

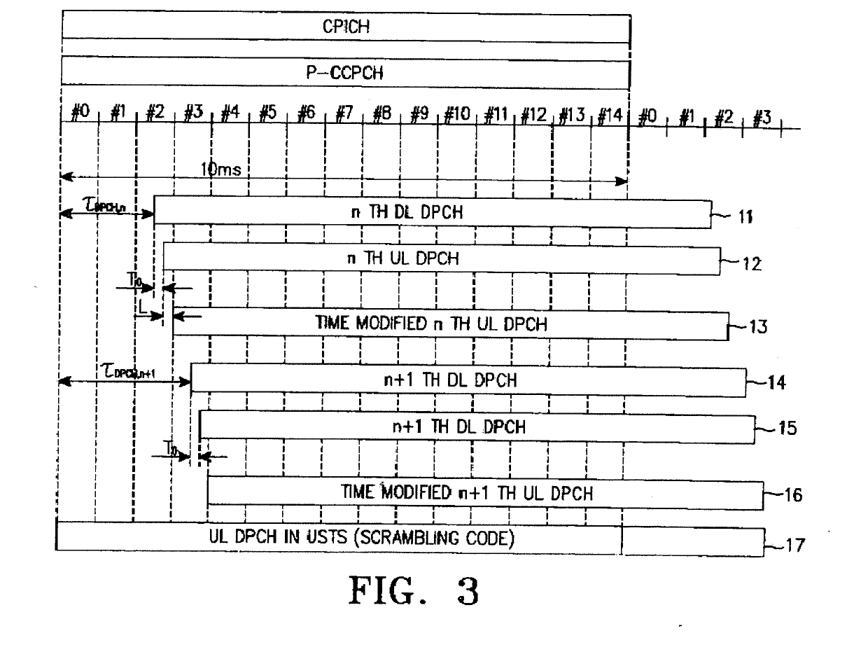

FIG. 3 illustrates the timing relationship when synchronization is performed in a USTS mode according to an embodiment of the present invention. Referring to FIG. 3, reference numeral 11 indicates a transmission time of the DL DPCH transmitted to an nth UE out of the UEs sharing a given scrambling code. The DL DPCH 11 transmitted to the n^{th} UE is transmitted after delay of a time offset τ_{DPCH,n} against the transmission time of the CPICH or the P-CCPCH. The respective DPCHs have different transmission times. Reference numeral 12 indicates a transmission time of the UL DPCH transmitted from the n^{th} UE. The UE transmits the UL DPCH at time Tₒ after receiving the DL DPCH. Therefore, the UEs have different UL DPCH transmission times. The USTS must synchronize the UL DPCHs with one another. Therefore, when performing communication using the USTS, a process for synchronizing the UL DPCHs is required. The embodiment of the present invention discloses a method for synchronizing the UL DPCHs transmitted from the UEs sharing the same scrambling code in the USTS mode. A method for initializing the USTS mode will be described with reference to a case of m=10.

(Step 1) Measurement of Propagation Delay (PD) from RACH Signal

Upon receipt of an RACH signal transmitted from the UE, the Node B measures a propagation delay (PD) value of the RACH signal. The measured PD value is used when the Node B assigns the DPCH.

(Step 2) Calculation of K=(τ_{DPCH,n}+Tₒ+2*PD) mod 2560

The Node B calculates a remainder K obtained by diving by 2560 the sum of a time offset τ_{DPCH,n} of a given DPCH, a constant Tₒ, and a value 2*PD measured in (Step 1). Here, the time offset τ_{DPCH,n} indicates a delay time (or time difference) between the P-CCPCH and the DL DPCH, and the constant Tₒ indicates a delay time between the DL DPCH and the UL DPCH transmitted to and from the UE. Further, the PD value indicates a propagation delay value, wherein ‘2560’ indicates the number of chips constituting one slot.

(Step 3) Transmission of L=2560−K to UE

The Node B calculates a value L using the value K, and then, transmits the calculated value L to the UE. Upon receipt of the value L, the UE transmits the UL DPCH, after the delay of the time Tₒ plus the time L from a reception time of the DL DPCH.

Step 3 above is a process for synchronizing the UEs in a slot (=2560 chip) unit. Although the synchronization is performed in a unit of a 2560-chip slot herein, it is also possible to perform the synchronization in a unit of a multiple of 256 chips in light of the property of the OVSF codes. Performing synchronization in a unit of a 2560-chip slot is an example of performing synchronization in a unit of 256*m chips where m=10. Here, the value ‘m’ can be either provided through a signaling message from an upper layer or previously determined. A process for performing synchronization in a unit of 256*m chips will be described below.

(Step 1) Measurement of Propagation Delay (PD)

Upon receipt of an RACH signal transmitted from the UE, the Node B measures the propagation delay value PD of the RACH signal. It is known that the measured PD value is used when the Node B assigns the DPCH. The PD value can be calculated in a chip unit. In this case, the PD value indicates a one-way propagation delay time between the Node Band the UE.

(Step 2) Calculation of K=(τ_{DPCH,n}+Tₒ+2*PD) mod 256*m

The Node B calculates a remainder K obtained by dividing by 256*m the sum of a time Offset τ_{DPCH,n} of a given DPCH, a constant Tₒ, and a value 2*PD measured in (Step 1).

(Step 3) Transmission of L=256*m−K to UE

The Node B calculates a value L using the value K, and then, transmits the calculated value L to the UE. Upon receipt of the value L, the UE transmits the UL DPCH, after the delay of the time Tₒ plus the time L from a reception time of the DL DPCH. In (Step 2), the time Offset τ_{DPCH,n} is previously defined as 256*K chips, and the value Tₒ is previously defined as 256*4 chips. Therefore, for m=1, the value K is equivalent to a remainder determined by dividing 2*PD by 256 (i.e., 2*PD mod 256). In (Step 3), the Node B transmits the value K instead of the value L to the UE. In this case, the UE calculates the value L from the value K, or uses the intact value K.

If the K value or the L value is less than a reference value (e.g., 128), the Node B transmits K (or L) so that the UE transmits the signal as early as the value K (or 256−L). However, if the K value of the L value is larger than the reference value, the Node B transmits +K (or +L) so that the UE transmits the signal as late as the value L. Upon receipt of the value K or the value L transmitted from the Node B, the UE may also transmit the UL DPCH, at time Tₒ−K after the reception time of the DL DPCH using the received value K, rather than transmitting the UL DPCH after the delay of the time To plus the time L from the receipt time of the DL DPCH. Therefore, upon receipt of the value L or the value K, the UE transmits the UL DPCH after calculating the value K or the value L in the above-stated method.

Alternatively, the Node B may transmit the PD value to the UE instead of transmitting the value L or the value K. In this case, upon receipt of the PD value transmitted from the Node B, the UE uses the received PD value in transmitting the UL DPCH considering the time offset τ_{DPCH,n} and the value Tₒ. For example, upon receipt of the PD value, the LE transmits the UL DPCH using a value Toff, which is determined by subtracting the 2*PD value from the value Tₒ after receiving the DL DPCH. Alternatively, the UE can also transmit the UL DPCH after the further delay of a time determined by adding a common propagation delay time T_all given in the system to the time Toff.

Next, the scrambling code synchronization process will be described.

Reference numeral 13 of FIG. 3 indicates a transmission time of the UL DPCH of the n^{th} UE, which is subjected to slot or 256-chip synchronization. Therefore, when received at the Node B, the n^{th} UE's UL DPCH is slot-synchronized. A sync error caused by the mobility of the UE during a time between transmission of the RACH signal and transmission of the UL DPCH can be modified by performing the tracking process.

Reference numerals 14, 15 and 16 of FIG. 3 indicate a DPCH transmission time of an (n+1)^{th} UE having a different time offset τ_{DPCH,n+1}. The (n+1)^{th} UE also undergoes the slot synchronization in the same method as used by the n^{th} UE.

In this method, it is possible to acquire the slot synchronization among the UEs sharing one scrambling code. Even though the slot synchronization is acquired, the frame synchronization may not be acquired according to the time offset τ_{DPCH,n+1}. In order for the UEs in a USTS group to use one scrambling code, it is necessary to time-align (or synchronize) the scrambling codes used by the UEs.

Reference numeral 17 of FIG. 3 indicates a method for aligning the scrambling codes from the UEs. In order for the UEs belonging to the USTS group using one scrambling code to acquire synchronization of the scrambling codes at the time when the Node B receives the UL DPCH, a separate scrambling code synchronization operation is required. Here, “synchronization of the scrambling codes” means that the scrambling codes start at the same time. That is, synchronization of the scrambling codes means that a start point C(0) of the scrambling codes C(i) where i=0,1, . . . ,38399, is time aligned.

It is not possible to acquire synchronization of the scrambling codes only by the process of performing synchronization in a unit of a slot or in a unit of 256*m chips. Therefore, for the synchronization of the scrambling codes, it is necessary to align the start points of the scrambling codes to a common reference time. FIG. 3 illustrates that for the synchronization of the scrambling codes, the frame start point of the CPICH or the P-CCPCH is used as the common reference time as represented by reference numeral 17.

When the frame start point of the CPICH or the P-CCPCH is used as the common reference time, the UEs in the USTS group start creating the scrambling codes in sync with the frame start point of the CPICH or the P-CCPCH. For example, the n^{th} UE starts frame synchronization of the UL DPCH 13 at a 4^{th} slot Slot#3. In this case, although the n^{th} UE's frame start point is the 4^{th} slot (i.e., Slot#3), a start point of the scrambling code is must be aligned to the first slot (Slot#0). That is, the start point of the scrambling code is not aligned with the frame start point of the UL DPCH. In the conventional method, the start point of the scrambling code is time-aligned with the frame start point of the UL DPCH. However, the embodiment of the present invention time-aligns the start point of the USTS scrambling code by separating the frame start point of the UL DPCH and the start point of the scrambling code.

The scrambling code synchronization process will be described below with reference to the n^{th} UE.

According to the prior art, since the frame start point of the UL DPCH is time-aligned with the start point of the scrambling code, the n^{th} UE uses the scrambling code which starts from C(0) at the 4^{th} slot (Slot#3). In the embodiment of the present invention, however, the frame start point of the P-CCPCH is used as the common reference time. Therefore, in order to use the scrambling code starting from C(0) at the 1^{st} slot (Slot#0), the n^{th} UE must know a scrambling code generated at the frame start point of the UL DPCH which starts at the 4^{th} slot (Slot#3). Since the scrambling code is comprised of 2560 chips per slot, the UE whose UL DPCH frame starts from the 4^{th} slot (Slot#3) uses a scrambling code starting from C(3*2560), and uses a scrambling code restarting from C(0) at the (Slot#0). That is, the UE changes the scrambling code C(i) (where i=0,1, . . . ,38399) to D(i)=C((i+3*2560) modulo 38400) (where i=0,1, . . . ,38399), and starts the scrambling code D(i) from D(0) beginning at the frame start point of the 4^{th} slot (Slot#3).

Therefore, each UE calculates the frame start point of the UL DPCH based on the time offset τ_{DPCH,n} and the value L, changes the scrambling code to D(i)=C((i+m*2560) modulo 38400) (where i=0,1, . . . ,38399) for the frame start point corresponding to the (m+1)^{th} slot (Slot#m), and uses the scrambling code starting from D(0) beginning at the frame start point.

In the foregoing description, the common reference time is defined as the frame start point of the P-CCPCH. However, the common reference time can also be determined by the Node B and broadcast to the UE employing the USTS.

As another example of determining the common reference time, the frame start point of the UL DPCH from the first assigned UE out of the UEs in the USTS using a given scrambling code is defined as the common reference time. Referring to FIG. 3, only the n^{th} UE and the (n+1)^{th} UE use the given scrambling code. When the n^{th} UE is first assigned the channel, the UE changes the scrambling code to D(i)=C((i+m*2560) modulo 38400) (where i=0,1, . . . ,38399) and uses a scrambling code starting from D(0) beginning at the frame start point as the common reference time. Further, the frame start point of the (n+1)^{th} UE, (i.e., the 4^{th} slot (Slot#3)) can also be defined as the scrambling code start point. Therefore, the Node B transmits to the (n+1)^{th} UE this information indicating that Slot#3 is the common reference time, so that the (n+1)^{th} UE acquires synchronization.

This embodiment discloses the scrambling synchronization method based on the slot synchronization. When synchronization is performed in a unit of 256*m chips, the scrambling synchronization method is as follows. In the 256*m-chip unit synchronization process, the UE determines the transmission time of the UL DPCH using the value L, the value K or the PD value. Since the UE and the Node B share the time offset value τ_{DPCH,n} and the value Tₒ, they know how the synchronization was performed in the 256*m-chip unit, depending on the value L, the value K and the PD value. Therefore, it is possible to search the scrambling start point based on the PD value or the value L.

For example, if(1) τ_{DPCH,n}=256*25 chips, (2) Tₒ=256*4 chips, (3) PD=1000 chips and (4) m=1, then the value L is calculated by L=256−[(τ_{DPCH,n}+Tₒ+PD) mod 256]=232.

The UE uses the value L calculated for the 256-chip unit synchronization. That is, the UE starts transmitting the UL DPCH frame after the delay of the T_{o+L} value from the frame start point of the received DL DPCH. Further, for the scrambling code synchronization, the UE determines a scrambling code offset using the frame start point of the received P-CCPCH and also using the PD value received from the Node B. The scrambling code offset refers to a time difference between the start point of the scrambling code designated as the reference time and the start point of the scrambling code of the current UE. That is, the UE changes the scrambling code to D(i)=C((i+offset_sc) modulo 38400) (where i=0,1, . . . ,38399), and uses the scrambling code starting from D(0) beginning at the frame start point. The scrambling code offset value offset_sc is calculated by

Offset_sc=τ_{DPCH,n} (1)

As stated above, the L value in Equation (1) has the following values.

L=256*m−((τ_{DPCH,n}+Tₒ+2*PD) mod 256*m) (Ex 1)

Therefore, it can be noted that the offset_sc value is a multiple of 256*m chips. The L value in Equation (1) can also be calculated by the following formula, and this is another example of the 256*m-chip unit synchronization.

L=−((τ_{DPCH,n}+Tₒ+2*PD) mod 256*m) (Ex 2)

The L value can also be defined as a general value, as follows.

L=K−((τ_{DPCH,n}+Tₒ+2*PD) mod 256*m) (Ex 3)

In the above formulas, the K value is a multiple of 256*m and is determined by the Node B. In particular, when the K value is not a multiple of 256*m, new synchronization other than the 256*m-chip unit synchronization may be required. (Ex 1) corresponds to the case where the K value is 256*m chips, while (Ex 2) corresponds to the case where the K value is 0. Further, in the above formulas, every value is measured and calculated in a chip unit. However, when the values are measured and calculated in a unit of (1/k) chips, the propagation delay value PD can be precisely measured in a unit of up to (1/k) chips. In this case, ‘mod 256*m’ in the above formulas must be exchanged with ‘mod 256*m*k’.

The offset value can either be calculated by the UE or directly provided to the UE from the Node B. By using the scrambling code synchronization method, the start points of the scrambling codes from the UEs supporting the USTS service may arrive at the same point at the Node B, because the P-CCPCH is set as the common reference time.

It is also possible to align the scrambling codes in sync with the first assigned UE. In this case, it is further necessary to transmit information through an upper layer signal for scrambling code synchronization. The RNC directly transmits the information to the UEs, for the synchronization. That is, the RNC transmits the L value for the 256*m-chip unit synchronization and transmit synchronization information of a reference UE for the scrambling code synchronization. For example, the RNC may also directly transmit the offset_sc value.

A method for aligning the scrambling codes in sync with the first assigned UE will be described below.

The Node B sets an offset value for the UE, which is first assigned a USTS scrambling code, to ‘0’. That is, the first UE aligns the frame start point with the scrambling code start point instead of synchronizing a specific scrambling code for the UL DPCH.

Meanwhile, when assigning the USTS channel to the scrambling code used by a plurality of UEs, a newly accessing UE receives an offset value for the scrambling code synchronization from the Node B. The received offset value can be calculated on the basis of the first assigned UE. In this case, since the respective UEs are primarily subjected to synchronization for the channelization code through the slot or 256*m-chip unit synchronization process, they calculate the offset value in a unit of 256*m chips. Here, the channelization code is an OVSF code used for separating the channels in the CDMA system.

The above-stated synchronization process will be described with reference to FIG. 3, in which it is assumed that the n^{th} UE is a UE which is first assigned the USTS scrambling code, and that m=10 in the slot or 256*m-chip unit synchronization process in the initial synchronization process. Referring to FIG. 3, the n^{th} UE aligns the frame start point and the scrambling code start point to Slot#2 after acquiring slot synchronization. That is, the offset value is ‘0’. Similarly, the (n+1)^{th} UE aligns the frame start point to Slot#3 after slot synchronization. In order to synchronize the scrambling code with the n^{th} UE, the scrambling code is synchronized with an offset of one slot or 256*10 chips. That is, the scrambling code start point is aligned to Slot#2. Thereafter, an offset value for the (n+1)^{th} UE becomes 256*10 chips.

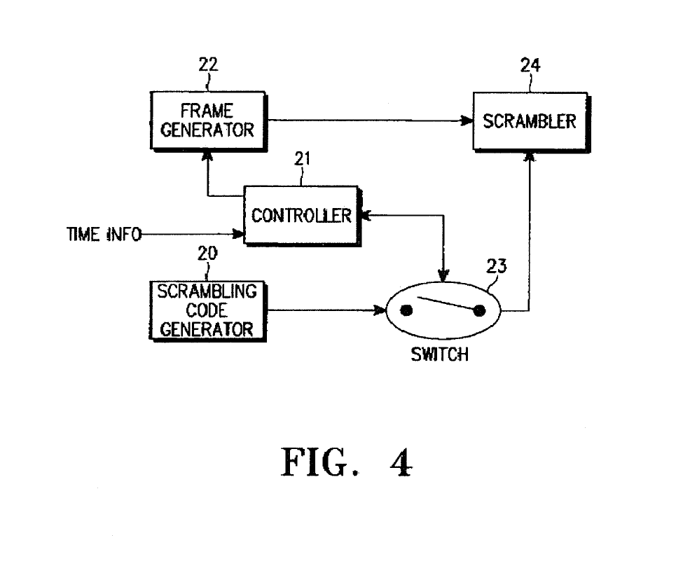

FIG. 4 illustrates a structure of a scrambling code synchronization apparatus for the UE according to an embodiment of the present invention. Referring to FIG. 4, a scrambling code generator 20 generates a scrambling code in sync with a given common reference time. That is, when the frame start time of the P-CCPCH is defined as the common reference time, the scrambling code generator 20 generates a scrambling code starting from C(0) beginning at the first slot Slot#0 of the P-CCPCH. Alternatively, when the frame start point of the first UE is set as the common reference time, the scrambling code generator 20 generates a scrambling code starting from C(0) beginning at the slot which becomes the frame start point of the first UE.

A controller 21 receives time information about the frame start point from the upper layer. The frame start point is calculated based on the time offset value τ_{DPCH,n} and the PD value. For example, in FIG. 3, the frame start point of the UE transmitting the n^{th} DPCH becomes Slot#3, and the frame start point of the UE transmitting the (n+1)^{th} DPCH becomes Slot#4. The controller 21 transmits the frame start point information to a frame generator 22 and a switch 23 based on the time information, so as to control the UE to start transmitting the UL DPCH. Upon receipt of the frame start point information from the controller 21, the frame generator 22 starts generating the frame at a given time and transmits the generated frame to a scrambler 24. Upon receipt of the frame start point information from the controller 21, the switch 23 transmits the scrambling code generated by the scrambling code generator 20 to the scrambler 24. The scrambler 24 spreads the frame received from the frame generator 22 using the scrambling code received from the scrambling code generator 20.

In operation of the scrambling code synchronization apparatus, the controller 21 drives the frame generator 22 at the frame start point in order to create the data frame to be transmitted over the DPCH. Further, the controller 21 turns ON the switch 23 at the frame start point so as to provide the scrambling code generated by the scrambling code generator 20 to the scrambler 24. The scrambling code generator 20 can generate the scrambling code in sync with the frame start point of the CPICH or the P-CCPCH. In this case, since the scrambling code is provided to the scrambler 24 beginning at the frame start point of the DPCH, the scrambling code generated at the frame start point of the DPCH may not be identical to C(0). That is, when the frame start point of the DPCH starts at the 3^{rd} slot, the DPCH data frame is spread with the scrambling code generated at the 3^{rd} slot. In addition, if the scrambling code generator 20 generates the scrambling code in sync with the frame start point of the first UE in the USTS group, to which the DPCH is assigned, instead of generating the scrambling code at the frame start point of the CPICH or the P-CCPCH, the controller 21 controls a time point for generating the scrambling code.

By using the scrambling code synchronization apparatus, it is possible to transmit the frame in sync with a given time offset by using the scrambling code time-aligned with the common reference time during transmission of UL DPCH of the USTS.

The scrambling code synchronization method according to the present invention acquires slot synchronization of the UEs in the USTS group and aligns the start points of the scrambling codes. Therefore, it is possible to reduce interference thanks to the time alignment of the scrambling codes and identify information from the UEs through the channelization code (e.g., OVSF code) by slot synchronization.

The handover type of the UE employing the USTS in the mobile communication system supporting the USTS service can be divided into one case where a new cell, (i.e., a target handover cell) provides a USTS handover and another case where the new cell does not provide the USTS handover.

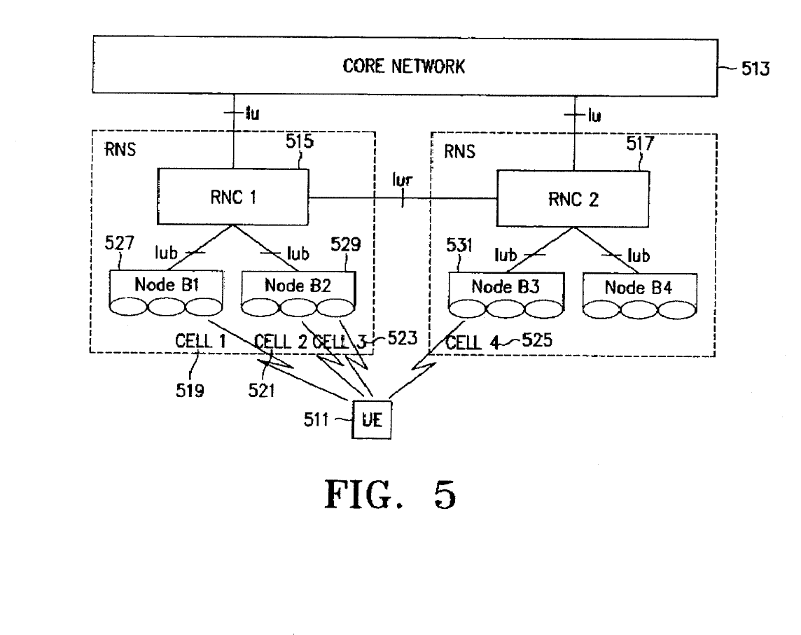

First, an operation of the system will be described with reference to the case where the new cell provides the USTS handover. When the new cell, a target cell to which the UE is to be handed over, provides the USTS handover, it is possible to perform a handover to the new cell while maintaining the USTS service in the current cell. For the communication service on the UE in the new cell, it is possible to use either the USTS service or a normal communication service, (i.e., a data service in which a normal DPCH not supporting the USTS service is assigned). In order to set up a new radio link in the new cell while maintaining the USTS service in the current cell, the SRNC transmits the following information to the Node B and the RNC corresponding to the new cell, as illustrated in FIGS. 5 to 8:

(1) UL scrambling code for the UE employing the USTS (USTS scrambling code)

(2) information on UL DPDCH and UL DPCCH channelization codes for the UE employing the USTS (USTS CH code NO)

(3) indicator indicating that the UE is employing the USTS (USTS indicator)

(4) scrambling code time offset information (USTS offset)

FIG. 5 illustrates a structure of a UTRAN in a W-CDMA mobile communication system, wherein a UE 511 is connected to the UTRAN. Referring to FIG. 5, a first RNC 515 connecting the UE 511 to a core network is called a “Serving RNC (SRNC)”, while a second RNC 517 assisting a connection to the SRNC 515 is called a “Drift RNC (DRNC).” FIG. 5 illustrates when the UE 511 sets up radio links to first through fourth cells 519, 521, 523 and 525. In this state, it is said that “the UE 511 exists in a handover area” or “the UE 511 is in a handover state”. The first cell 519 having a radio link connected to the UE 511 exists in a first Node B 527, the second and third cells 521 and 523 exist in a second Node B 529, and the fourth cell 525 exists in a third Node B 531.

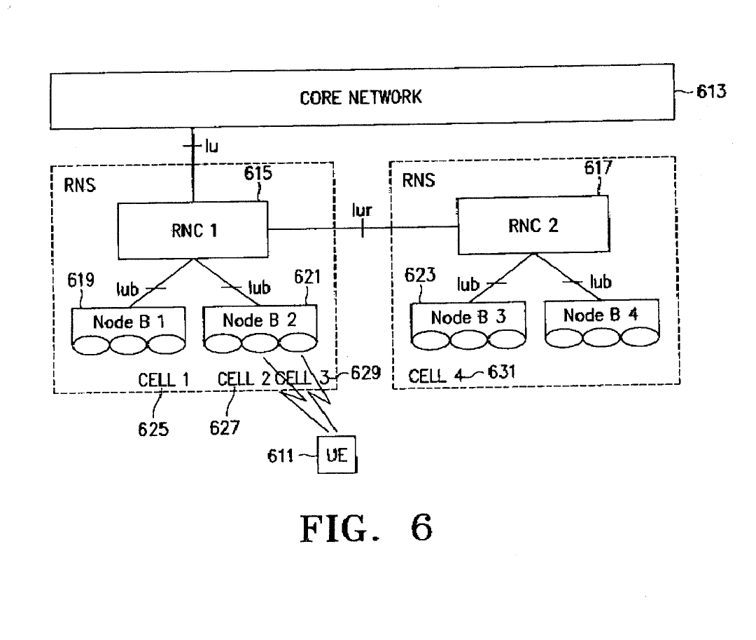

FIG. 6 illustrates a structure of a UTRAN in a W-CDMA mobile communication system, wherein a handover of a UE is performed within the same Node B according to another embodiment of the present invention. Referring to FIG. 6, a UE 611 performs an operation of setting up a new radio link to a third cell 629 in a second Node B 621, while maintaining a radio link connected to a second cell 627 in the same Node B 621. For the handover performed within the same Node B, the following message is required. Upon receipt of information on a basic measurement value for the handover from the UE 611, a first RNC (SRNC) 615 sets to perform a handover and then transmits an NBAP (Node B Application Part) message to the second Node B 621 through a lub interface. The transmitted NBAP message is a Radio Link Addition Request message for setting up a new radio link.

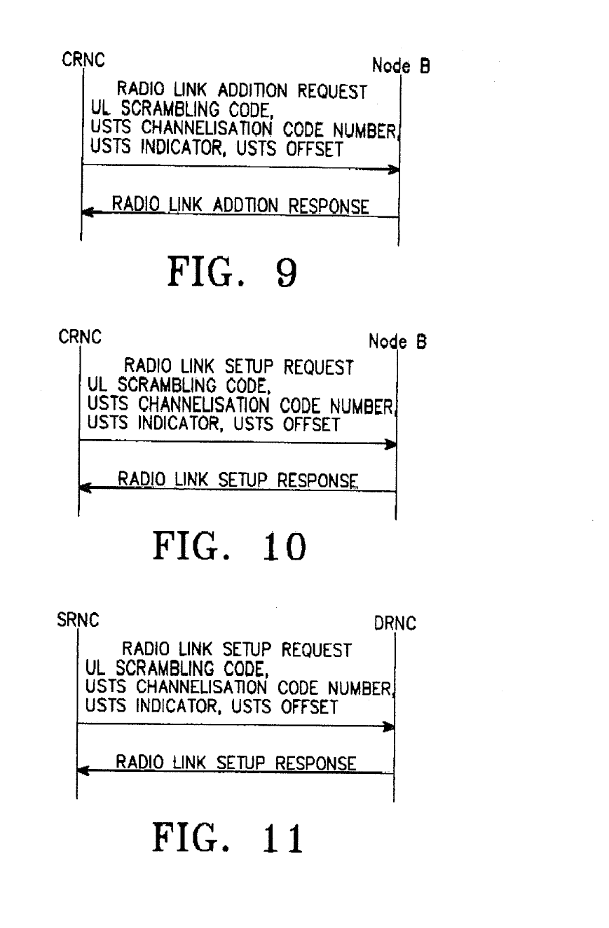

FIG. 9 illustrates a process for transmitting a Radio Link Addition Request message to another cell in the same Node B during a USTS handover according to another embodiment of the present invention. Referring to FIG. 9, the Radio Link Addition Request message includes separate parameters for the USTS handover in addition to the handover parameters. The parameters for the USTS handover are shown in Table 1 below, which will be described later. Upon receipt of the parameter information for the USTS handover, the second node B 621 sets up a new radio link to the UE 611 and exchanges data through the new radio link.

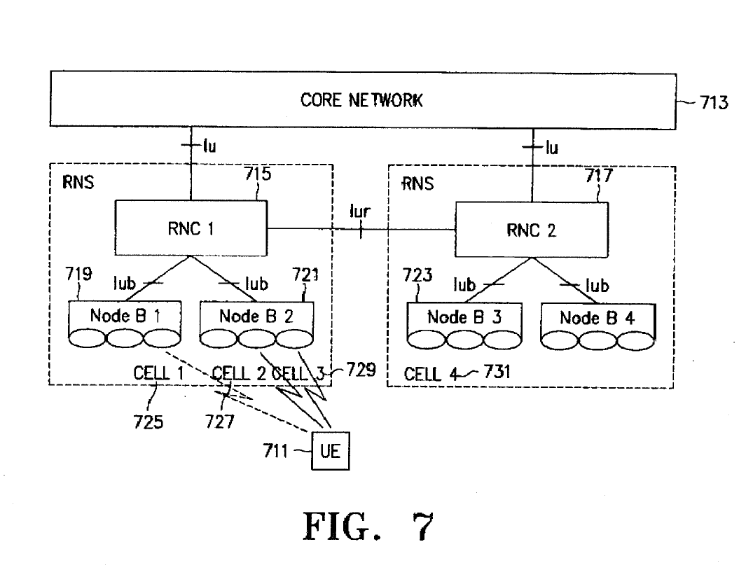

FIG. 7 illustrates a structure of a UTRAN in a W-CDMA mobile communication system, wherein a handover of a UE is performed to another Node B within the same RNC according to another embodiment of the present invention. Referring to FIG. 7, a UE 711 performs an operation of setting up a new radio link to a first cell 725 in a first Node B 719, while maintaining radio links connected to second and third cells 727 and 729 in a second Node B 721. For the handover performed to another Node B within the same RNC, the following message is required. Upon receipt of information on a basic measurement value for the handover from the UE 711, a first RNC (SRNC) 715 sets to perform a handover and then transmits an NBAP message to the first Node B 719 through a lub interface. The transmitted NBAP message is a Radio Link Setup Request message.

FIG. 10 illustrates a process for transmitting a Radio Link Setup Request message to another Node B within the same RNC during a USTS handover according to another embodiment of the present invention. Referring to FIG. 10, the Radio Link Setup Request message includes separate parameters for the USTS handover in addition to the handover parameters. The parameters for the USTS handover are shown in Table 1, which will be described later. Upon receipt of the parameter information for the USTS handover, the first node B 719 sets up a new radio link to the UE 711 and exchanges data through the new radio link.

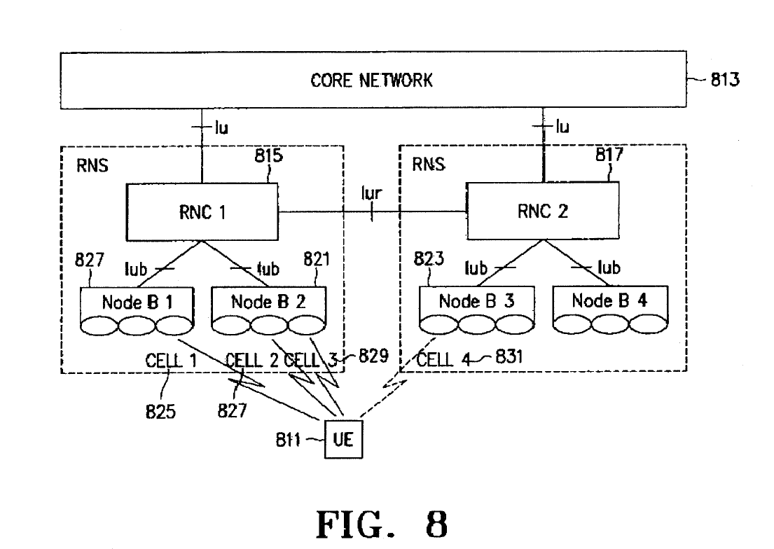

FIG. 8 illustrates a structure of a UTRAN in a W-CDMA mobile communication system, wherein a handover of a UE is performed to a cell within another RNC according to another embodiment of the present invention. Referring to FIG. 8, a UE 811 performs an operation of setting up a new radio link to a fourth cell 831 in a second RNC 817, while maintaining radio links connected to first, second and third cells 825, 827 and 829 in a first RNC 815. For the handover performed to a cell within another RNC, the following message is required. Upon receipt of information on a basic measurement value for the handover from the UE 811, the first RNC (SRNC) 815 sets to perform a handover and then transmits an RNSAP (RNS Application Part) message to the second RNC 817 through a lub interface. The transmitted RNSAP message is a Radio Link Setup Request message.

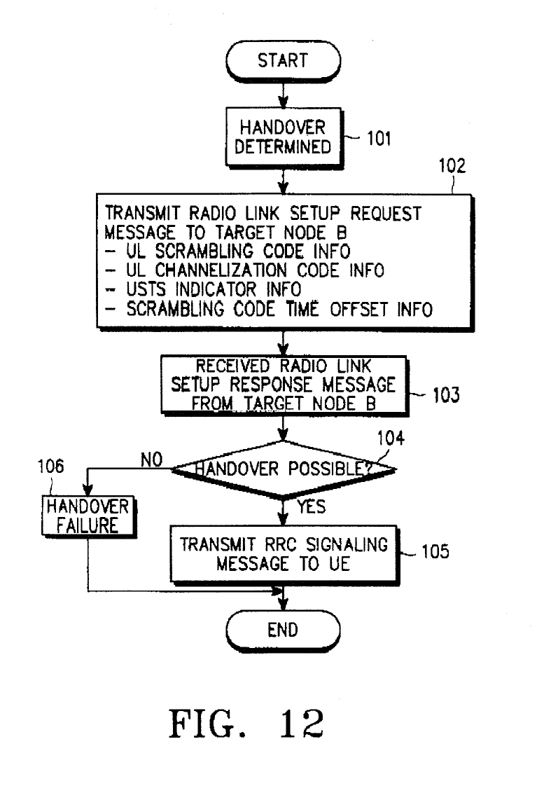

FIG. 11 illustrates a process for transmitting a Radio Link Setup Request message to a cell in another RNC during a USTS handover according to another embodiment of the present invention. Referring to FIG. 11, the Radio Link Setup Request message includes separate parameters for the USTS handover in addition to the handover parameters. The parameters for the USTS handover are shown in Table 1, which will be described later. Upon receipt of the parameter information for the USTS handover, a fourth Node B 831 sets up a new radio link to the UE 811 and exchanges data through the new radio link.

In sum, when the handover is performed as illustrated in FIGS. 6 and 9, the RNC performs a process for creating, at a handoff request, a Radio Link Addition Request message including the USTS parameters comprised of the UL scrambling code information, the USTS indicator for indicating that the handover-requesting UE is employing the USTS, the channelization code information for the dedicated channel of the UE, and the scrambling code time offset information, and then transmitting the created Radio Link Addition Request message to the Node B, and a process for performing a handover upon receipt of a Radio Link Addition Response message from the Node B and servicing the handover channel in the USTS mode.

Further, the Node B performs a process for receiving from the RNC the Radio Link Addition Request message including the USTS parameters comprised of the UL scrambling code information, the USTS indicator for indicating that the handover-requesting UE is employing the USTS, the channelization code information for the dedicated channel of the UE, and the scrambling code time offset information, and a process for transmitting a Radio Link Addition Response message to the RNC upon receipt of the Radio Link Addition Request message, assigning a handover channel according to the received channelization code information, setting a frame start point at a scrambling code start point according to the scrambling code time offset information, and performing a handover at the set frame start point.

In addition, when the handover is performed as illustrated in FIGS. 7 and 10, the RNC performs a process for creating, at a handoff request, a Radio Link Setup Request message including the USTS parameters comprised of the UL scrambling code information, the USTS indicator for indicating that the handover-requesting UE is employing the USTS, the channelization code information for the dedicated channel of the UE, and the scrambling code time offset information, and then transmitting the created Radio Link Setup Request message to another Node B, and a process for performing a handover upon receipt of a Radio Link Setup Response message from another Node B and servicing the handover channel in the USTS mode.

Further, the Node B performs a process for receiving from the RNC the Radio Link Setup Request message including the USTS parameters comprised of the UL scrambling code information, the USTS indicator for indicating that the handover-requesting UE is employing the USTS, the channelization code information for the dedicated channel of the UE, and the scrambling code time offset information, and a process for transmitting a Radio Link Setup Response message to the RNC upon receipt of the Radio Link Setup Request message, assigning a handover channel according to the received channelization code information, setting a frame start point at a scrambling code start point according to the scrambling code time offset information, and performing a handover at the set frame start point.

Next, when the handover is performed as illustrated in FIGS. 8 and 11, a first RNC performs a process for creating, at a handoff request, a Radio Link Setup Request message including the USTS parameters comprised of the UL scrambling code information, the USTS indicator for indicating that the handover-requesting UE is employing the USTS, the channelization code information for the dedicated channel of the UE, and the scrambling code time offset information, and then transmitting the created Radio Link Setup Request message to a second RNC to which the UE is to be handed over, and a process for performing a handover upon receipt of a Radio Link Setup Response message from the second RNC and performing the handover at a set time.

Further, the Node B performs a process for receiving from the first RNC the Radio Link Setup Request message including the USTS parameters comprised of the UL scrambling code information, the USTS indicator for indicating that the handover-requesting UE is employing the USTS, the channelization code information for the dedicated channel of the UE, and the scrambling code time offset information, and a process for transmitting a Radio Link Setup Response message to the first RNC upon receipt of the Radio Link Setup Request message and transmitting the USTS parameters to the corresponding Node B, so that the Node B can assign a handover channel according to the received channelization code information, sets a frame start point at a scrambling code start point according to the scrambling code time offset information, and perform a handover at the set frame start point.

Tables 1 to 3 below, show various formats of the Radio Link Setup Request message of the NBAP message, in which the USTS parameters are inserted. It is also possible to transmit the USTS parameters using the similar format even for the Radio Link Setup Request message of the RNSAP message and the Radio Link Addition Request message of the NBAP message.

Specifically, Table 1 corresponds to a case where one UE uses only one DPDCH, and Tables 2 and 3 correspond to a case where one UE can have a plurality of DPDCHs. It is assumed in Table 2 that unlike the normal DPDCH, the UE can have a plurality of channelization codes even though SF (Spreading Factor) is not 4, and the channelization codes have the same SF. Further, it is assumed in Table 3 that unlike the normal DPDCH, the UE can have a plurality of channelization codes even though SF is not 4, and the channelization codes have the different SFs.

In Tables 1 to 3, a USTS Indicator indicates that the US is employing the USTS, and a USTS Channelization Code Number indicates information (USTS CH code NO) on the channelization code numbers for the UL DPDCH and the UL DPCCH of the UE employing the USTS. In addition, a USTS offset indicates the scrambling code time offset information. Further, a UL Scrambling Code indicates a UL scrambling code of the UE employing the USTS, and for this, the existing message information, i.e., the UL scrambling code information is used.

Table 1 shows a format of the Radio Link Setup Request (or Radio Link Addition Request) message for the USTS handover according to an embodiment of the present invention, wherein one UE uses only one DPDCH.

TABLE 1

| | | | IE type | | | |
|---|---|---|---|---|---|---|
| | | | and | Semantics | | Assigned |
| IE/Group Name | Presence | Range | reference | description | Criticality | Criticality |
| Message Discriminator | M | | 9.2.1.45 | | | |
| Message Type | M | | 9.2.1.46 | | YES | reject |
| CRNC | M | | 9.2.1.18 | | YES | reject |
| Communication | | | | | | |
| Context ID | | | | | | |
| Transaction ID | M | | 9.2.1.62 | | | |
| UL DPCH | | 1 | | | YES | reject |
| Information | | | | | | |
| >UL Scrambling Code | M | | 9.2.2.59 | | | |
| >Min UL | M | | 9.2.2.22 | | | |
| Channelisation Code | | | | | | |
| length | | | | | | |
| >Max Number of UL | C | | 9.2.2.21 | | | |
| DPDCHs | CodeLen | | | | | |
| >puncture limit | M | | 9.2.1.50 | for UL | | |
| >TFCS | M | | 9.2.1.58 | for UL | | |
| >UL DPCCH Slot | M | | 9.2.2.57 | | | |
| Format | | | | | | |
| >UL SIR Target | M | | UL SIR | | | |
| | | | 9.2.2.58 | | | |
| >Diversity mode | M | | 9.2.29 | | | |
| >D Field Length | C FB | | 9.2.2.5 | | | |
| >SSDT cell ID Length | O | | 9.2.2.45 | | | |
| >S Field Length | O | | 9.2.2.40 | | | |
| >USTS Indicator | O | | | | | |
| >USTS Channelisation | C | | | | | |
| Code Number | USTS | | | | | |
| -Omitted- | | | | | | |
| RL Information | | 1 to | | | EACH | notify |
| | | <maxnoofRLs> | | | | |
| >RL ID | M | | 9.2.1.53 | | | |
| >C-ID | M | | 9.2.1.9 | | | |
| >First RLS Indicator | M | | | | | |
| >Frame Offset | M | | 9.2.1.31 | | | |
| >Chip Offset | M | | 9.2.2.2 | | | |
| >Propagation Delay | O | | 9.2.2.35 | | | |
| >Diversity Control | C | | 9.2.2.7 | | | |
| Field | NotFirstRL | | | | | |
| >USTS offset | | | | | | |
| -Omitted- | | | | | | |

In Table 1, a USTS Channelization Code Number (USTS CH code NO) indicates a corresponding number in the OVSF code tree for a given SF in Min UL Channelization Code Length. For example, if SF=4, the USTS Channelization Code Number has one of the values 0, 1, 2 and 3. The USTS Channelization Code Number of 0 indicates the highest code node in the OVSF code tree, the USTS Channelization Code Number of 1 indicates the second highest code node in the OVSF code tree, the USTS Channelization Code Number of 2 indicates the third highest code node in the OVSF code tree, and the USTS Channelization Code Number of 3 indicates the lowest code node in the OVSF code tree. In Table 1, the USTS Channelization Code Number is marked with ‘C USTS’ in a Presence column, since this information is necessary only for the USTS handover. This indicates that the USTS Channelization Code Number is Conditional information which is required only for the USTS service or required only when there exists the USTS Indicator.

In Table 1, a USTS offset indicates the scrambling code time offset information. The new cell can approximately synchronize the uplink and the downlink for the UE using a Frame Offset value and a Chip Offset value transmitted from the SRNC. However, the UE employing the USTS does not align the scrambling code start point with the frame start point during transmission of the UL DPCH, so that the new cell must receive the scrambling code time offset information in order to search the scrambling code start point.

The scrambling code time offset value can be defined as a value which is created when the UE employing the USTS sets an offset by separating the scrambling code start point from the frame start point in order to align the UL scrambling codes to the UEs using the same scrambling code. As a result, upon receipt of the scrambling code time offset, the new cell searches the start point of the scrambling code for the UL DPCH depending on the received scrambling code time offset. For example, the scrambling code time offset is used for the offset value in Table 1.

Table 2 shows a format of the Radio Link Setup Request (or Radio Link Addition Request) message in the W-CDMA mobile communication system supporting the USTS service according to another embodiment of the present invention, wherein one UE uses a plurality of DPDCHs and the same SF.

TABLE 2

| | | | IE type | | | |
|---|---|---|---|---|---|---|
| | | | and | Semantics | | Assigned |
| IE/Group Name | Presence | Range | reference | description | Criticality | Criticality |
| Message Discriminator | M | | 9.2.1.45 | | | |
| Message Type | M | | 9.2.1.46 | | YES | reject |
| CRNC | M | | 9.2.1.18 | | YES | reject |
| Communication | | | | | | |
| Context ID | | | | | | |
| Transaction ID | M | | 9.2.1.62 | | | |
| UL DPCH | | 1 | | | YES | reject |
| Information | | | | | | |
| >UL Scrambling | M | | 9.2.2.59 | | | |
| Code | | | | | | |
| >Min UL | M | | 9.2.2.22 | | | |
| Channelisation Code | | | | | | |
| length | | | | | | |
| >Max Number of UL | C | | 9.2.2.21 | | | |
| DPDCHs | CodeLen | | | | | |
| (Removable) | | | | | | |
| -Omitted- | | | | | | |
| >USTS Indicator | O | | | | | |
| >USTS | C USTS | 1 to | | | | |
| Channelisation | | <maxnoofCH> | | | | |
| Code Information | | | | | | |
| >>USTS | M | | | | | |
| Channelisation | | | | | | |
| Code Number | | | | | | |
| -Omitted- | | | | | | |
| RL Information | | 1 to | | | EACH | notify |
| | | <maxnoofRLs> | | | | |
| >RL ID | M | | 9.2.1.53 | | | |
| >C-ID | M | | 9.2.1.9 | | | |
| >First RLS Indicator | M | | | | | |
| >Frame Offset | M | | 9.2.1.31 | | | |
| >Chip Offset | M | | 9.2.2.2 | | | |
| >Propagation Delay | O | | 9.2.2.35 | | | |
| >Diversity Control | C | | 9.2.2.7 | | | |
| Field | NotFirstRL | | | | | |
| >USTS offset | C USTS | | | | | |
| -Omitted- | | | | | | |

Table 2 corresponds to a case where a plurality of channelization code nodes are used for one SF. Therefore, in Table 2, USTS Channelization Code Information indicates a USTS channelization code number which can be repeated as many times as the number of channels assigned to one group and are required every time. Therefore, in Table 2, the USTS Channelization Code Number (USTS CH code NO) indicates a corresponding number in the OVSF code tree for a given SF in Min UL Channelization Code Length. For example, if SF=8, the USTS Channelization Code Number has some of the values 0,1, . . . ,7. Max Number of UL DPDCHs is removable from Table 2.

Table 3 shows a format of the Radio Link Setup Request (or Radio Link Addition Request) message in the W-CDMA mobile communication system supporting the USTS service according to another embodiment of the present invention, wherein one UE uses a plurality of DPDCHs and the different SFs.

TABLE 3

| | | | IE type | | | |
|---|---|---|---|---|---|---|
| | | | and | Semantics | | Assigned |
| IE/Group Name | Presence | Range | reference | description | Criticality | Criticality |
| Message Discriminator | M | | 9.2.1.45 | | | |
| Message Type | M | | 9.2.1.46 | | YES | Reject |
| CRNC | M | | 9.2.1.18 | | YES | Reject |
| Communication | | | | | | |
| Context ID | | | | | | |
| Transaction ID | M | | 9.2.1.62 | | | |
| UL DPCH | | 1 | | | YES | Reject |
| Information | | | | | | |
| >UL Scrambling | M | | 9.2.2.59 | | | |
| Code | | | | | | |
| >Min UL | M | | 9.2.2.22 | | | |
| Channelisation | | | | | | |
| Code length | | | | | | |
| (Removable) | | | | | | |
| >Max Number of | C | | 9.2.2.21 | | | |
| UL DPDCHs | CodeLen | | | | | |
| (Removable) | | | | | | |
| -Omitted- | | | | | | |
| >USTS Indicator | O | | | | | |
| >USTS | C USTS | 1 to | | | | |
| Channelisation | | <maxnoofCH> | | | | |
| Code Information | | | | | | |
| >Min UL | M | | | | | |
| Channelisation | | | | | | |
| Code length | | | | | | |
| >>USTS | M | | | | | |
| Channelisation | | | | | | |
| Code Number | | | | | | |
| -Omitted- | | | | | | |
| RL Information | | 1 to | | | EACH | notify |
| | | <maxnoofRLs> | | | | |
| >RL ID | M | | 9.2.1.53 | | | |
| >C-ID | M | | 9.2.1.9 | | | |
| >First RLS | M | | | | | |
| Indicator | | | | | | |
| >Frame Offset | M | | 9.2.1.31 | | | |
| >Chip Offset | M | | 9.2.2.2 | | | |
| >Propagation | O | | 9.2.2.35 | | | |
| Delay | | | | | | |
| >Diversity Control | C | | 9.2.2.7 | | | |
| Field | NotFirstRL | | | | | |
| >USTS offset | C | | | | | |
| -Omitted- | USTS | | | | | |

Table 3 corresponds to a case where a plurality of channelization code nodes are used for several SFs. In this case, a Min UL Channelization Code Length and a Max Number of UL DPDCHs are removable from Table 3. In Table 3, USTS Channelization Code Information indicates Min UL Channelization Code Length for SF information and a USTS channelization code number, which is repeated as many times as the number of channels assigned to one group and are required every time. Therefore, in Table 3, the Min UL Channelization Code Length can have one of the values 4, 8, 16, 32, 64, 128 and 256. In each case, the USTS Channelization Code Number indicates a corresponding number in the OVSF code tree for a given SF in Min UL Channelization Code Length. For example, if SF=8, the USTS Channelization Code Number has some of the values 0,1, . . . ,7.

It is assumed in Tables 1 to 3 that the channelization code for the UL DPCCH is not notified with separate information. That is, it is possible not to notify the separate information by previously determining a specific rule between the DPDCH and the DPCCH such that a specially mapped SF=256 channelization code node should be used for the DPCCH, when a certain OVSF code node is assigned to the channelization code for the DPDCH. Of course, when the channelization code node to be used for the DPCCH is not previously designated, information indicating the channelization code node for the DPCCH must be additionally inserted in the above tables. Since the SF=256 channelization code node is always used for the DPCCH, it is necessary to notify which of the SF=0 to SF=254 code nodes is to be used.

Meanwhile, the UL scrambling code of a UE operated based on USTS can be transmitted in the same form as information transmitted on a typical DPCH. Because the UL scrambling code is for USTS in the cell, a new cell to which the UE hands over a call must know the USTS scrambling code beforehand. USTS scrambling codes are known in many ways.

(1) The first way is to transmit a the USTS indicator. A cell receiving the USTS indicator (a corresponding Node B or RNC) recognizes the UE uses USTS and a different handover from that on a typical DPCH is required.

(2) Some UL scrambling codes are preset for USTS in the same manner as saving part of the UL scrambling codes for RACHs or CPCHs. Then, the SRNC transmits the UL scrambling codes for USTS to the Node B or RNC so that the Node B or RNC recognizes that the UE uses the USTS.

(3) The third way relies on a presence or an absence of channelization code information. If there is information about the scrambling code and DPCCH channelization code of the UE using the USTS, this implies that the handover UE uses the USTS. This is because such channelization code information is different from that for a typical DPCH.

Once the UE succeeds in establishing a new radio link, it continues the USTS service in one cell and performs a general DPCH or USTS service in other cells. If this procedure is repeated, there may be a case where one UE is connected to one cell by a USTS service and to at least one other cell on a DPCH. In this case, the UE collectively receives data from the plurality of cells as one piece of information. The cell, with which the UE communicates for the USTS service, may utilize part of TPC information for a different use, that is, as a TAB (Time Alignment Bit) for tracking. Accordingly, the UE needs to recognize the TAB separately from the information received from the cells.

Now, the operations of each UE, the SRNC, and the Node B for a handover of a UE using the USTS will be described below.

The UE transmits UL data while maintaining the USTS service. That is, the UE establishes a new radio link while maintaining the USTS service where a scrambling code start point differs from a frame start point, (i.e., the start point of an uplink data frame) and then receives data from different cells collectively as one piece of information. Since the cell connected to the UE by the USTS service uses part of TPC information as a TAB for tracking, the UE interprets the TAB separately from the TPC information received from the other cells. Thus, the UE maintains tracking for the USTS using the TAB from the USTS-connected cell, and neglects the TPC information received from the other cells at the same time point or uses it for power control.

A description of the SRNC will be given below with reference to FIG. 12.

FIG. 12 is a flowchart illustrating the operation of the SRNC during a handover. In step 101, the SRNC receives a measurement report from the UE and determines a handover for the UE. The SRNC transmits a Radio Link Setup Request message to the Node B of a new cell in step 102. The Radio Link Setup Request message includes USTS parameters for a USTS handover. The USTS parameters are the UL scrambling code information, the UL channelization code information, the USTS indicator information, and the scrambling code time offset information. The USTS parameters, information about the UE using the USTS, are stored in the SRNC. In step 103, the SRNC receives a Radio Link Setup Response message from the target Node B in response to the Radio Link Setup Request message. The SRNC determines whether the handover is possible by analyzing the Radio Link Setup Response message in step 104. If the USTS handover is possible, the SRNC goes to step 105, and otherwise, the SRNC goes to step 106.

It is determined that the USTS handover is impossible in step 104 in the following cases: (1) the target Node B does not support the USTS; (2) although the target Node B supports the USTS, it does not support the USTS handover; or (3) the USTS handover fails as in the conventional technology. In step 105, the SRNC transmits an RRC signaling message to the UE for handover. Here, the RRC signaling message is an Active Set Update message containing the same contents as a message transmitted during a handover in the conventional technology. Meanwhile, the SRNC ends the procedure with the USTS maintained, considering the handover is failed in step 106.

In the above description of the USTS handover, it is assumed that the SRNC is identical to a CRNC and the new cell is in a different Node B. If the new cell is in the same Node B, the Radio Link Setup Response message is replaced by a Radio Link Addition Request message in the case illustrated in FIG. 6. On the other hand, if the SRNC is different from the CRNC, that is, the UE is connected to the SRNC via a DRNC, the SRNC transmits the USTS parameters to the target Node B via the DRNC in step 102. Here, the Radio Link Setup Request message being an RNSAP message is used between the SRNC and the DRNC. The DRNC transmits the USTS parameters using a Radio Link Setup Request message being an NBAP message to the target Node B of the new cell.

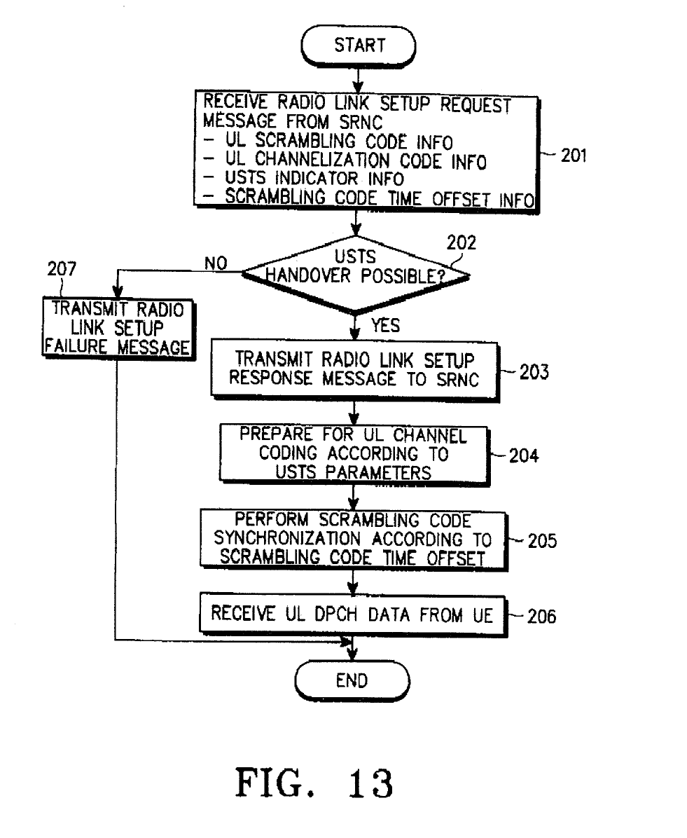

Referring to FIG. 13, the operation of the Node B will be described.

FIG. 13 is a flowchart illustrating the operation of the Node B in a new cell for the handover. In step 201, the target Node B receiving the handover request receives a handover-related message from the SRNC. It is assumed herein that the new cell is in a different Node B from that of the UE. Therefore, the handover-related message is an NBAP message, a Radio Link Setup Response message. On the other hand, if the new cell is in the same Node B, the handover-related message is a Radio Link Addition Request message. The Radio Link Setup Request message includes the USTS parameters, that is, the UL scrambling code information, UL channelization code information, USTS indicator information, and scrambling code time offset information, for USTS handover, as stated before.

In step 202, the target Node B determines whether the USTS handover is possible. That is, upon receipt of the Radio Link Setup Response message, the target Node B determines whether it will support the USTS handover. If the USTS handover is impossible, the target Node B transmits a Radio Link Setup Failure message to the SRNC in step 207 and ends the procedure.

If the handover is possible in step 202, the target Node B transmits the Radio Link Setup Response message to the SRNC in response to the received Radio Link Setup Request message in step 203 and prepares for UL channel coding according to the USTS parameters set in the received Radio Link Setup Response message in step 204. In step 205, the target Node B performs scrambling code synchronization by the difference between a frame start point and a scrambling code start point according to the scrambling code time offset. Specifically, the target Node B shifts the scrambling code from the frame start point by the scrambling code time offset for synchronization of scrambling codes to thereby prepare for spreading. In step 206, the target Node B receives the UL DPCH data from the UE using the results prepared in steps 204 and 205 and ends the procedure.

In the description of the handover operation of the target Node B, the target Node B knows that the UE is receiving the USTS service from the cell of a different Node B or the cell of the same Node B. Therefore, the target Node B also recognizes that the UE continues synchronization by tracking at every frame according to the USTS service. To synchronize at a frame level, the UE transmits UL data on a 1/n chip basis and thus it operates suitably. Or the fact that the UE may not respond to the last TPC value is utilized.

In another embodiment of the present invention, conversion (or switching) from a typical DPCH connection state (i.e., a normal mode or a non-USTS mode) to a USTS mode will be described.

If the SRNC determines that the UE operating in the USTS mode becomes remote from the cell providing the USTS service, it discontinues the USTS service and uses the typical DPCH, or performs the USTS operation in a cell with the highest signal strength. The USTS operation is a Radio Link Reconfiguration procedure.

In the Radio Link Reconfiguration procedure, the SRNC terminates the USTS mode of the UE and transitions the UE to a normal mode or a non-USTS mode, or vice versa. Both mode conversions may occur simultaneously.

The “normal mode” refers to assignment of a typical DPCH to the UE. The “non-USTS mode”, used discriminatively from the normal mode, occurs to a UE which being requested to establish a radio link with a new cell due to its mobility in the USTS mode, is connected to other cells by typical DPCHs, while maintaining the USTS service with the current serving cell.

For conversion from the normal mode to the USTS mode, information set in the Radio Link Setup message or the Radio Link Addition message is transmitted by the Radio Link Reconfiguration message. When the UE requesting conversion to the USTS mode is connected to a new cell by a handover, the UE and the new cell are connected on typical DPCHs. If the UE is released from the connection to the old USTS service-providing cell, the UE receives a general DPCH service. If the new cell is capable of providing the USTS service, the SRNC converts the normal mode to the USTS mode again by the Radio Link Reconfiguration procedure.

Mode conversions of the UE will be described herein below. Two cases may occur to a UE receiving the USTS service from a cell on a radio link. In one case, the UE is first assigned a USTS scrambling code. In the other case, the UE is assigned the USTS scrambling code while it is in use for other UEs for the USTS service.

As to the former case, (1) the SRNC transmits information about UL scrambling codes for USTS, and UL DPDCH and DPCCH channelization code information, that is, USTS parameters to the Node B. The USTS parameters are transmitted by a Radio Link Reconfiguration message or another signaling message. (2) The Node B transmits time information measured on the radio link established with the SRNC. The time information is one of the time difference between the start point of a current received UE frame and that of a P-CCPCH frame, a value required to make the time difference equal to 256*m chips, and a PD. The PD is calculated by subtracting To from the difference between the start points of a corresponding DP DPCH frame and a UL DPCH frame. (3) The SRNC transmits time information received from the Node B to the UE. (4) The UE performs USTS uplink transmission using the time information received from the SRNC.

When the UE is first assigned a USTS scrambling code, the UE, the SRNC, and the Node B operate in the following manner.

First, the UE sends a request for conversion to the USTS mode to the Node B during communication over a DPCH, or the Node B attempts conversion to the USTS mode for the UE that is receiving a normal mode or a non-USTS mode after the USTS mode. The UE transmits UL DPCH data based on a time offset for USTS in the information received from the SRNC for conversion to the USTS mode. If the time offset is 0, the UE performs the conventional DPCH operation. On the contrary, if the time offset is not 0, the UE performs synchronization by the time offset. The time offset is information required to make the difference between the start points of a current received UE frame and a P-CCPCH frame equal to 256*m chips, that is, time information representing how earlier or later the UE should transmit a UL DPCH with respect to the previous UL DPCH, or information about a PD generated during transmission of a UL DPCH. Upon receipt of the PD, the UE transmits the UL DPCH earlier by the PD.

The SRNC determines the time offset, and the UE receiving the time offset transmits the UL DPCH earlier or later by the time offset. If the UE is the first one to transition to the USTS mode, that is, there is no UE receiving the USTS service, the UE becomes a reference UE for the other UEs. If a USTS scrambling code is synchronized based on a P-CCPCH, the UE can perform scrambling code synchronization. In this case, the SRNC transmits time information for the scrambling code synchronization and the UE, upon receipt of the time information, delays the scrambling code by the time offset prior to transmission. The scrambling code synchronization is performed by the UE scrambling code synchronizer illustrated in FIG. 4.

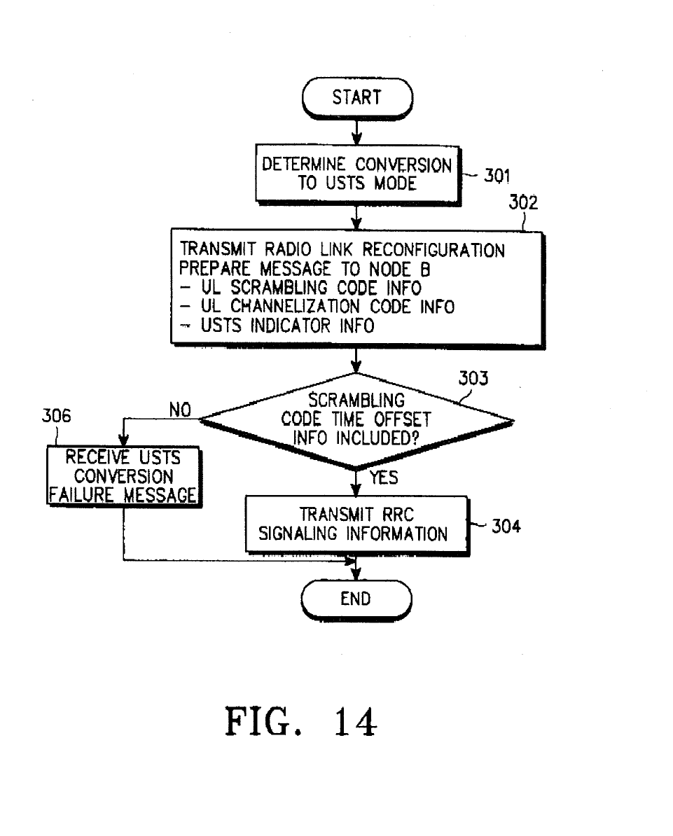

Now, the operation of the SRNC will be described with reference to FIG. 14.

FIG. 14 is a flowchart illustrating the operation of the SRNC when the UE is transitioned to the USTS mode during communication on a DPCH. Referring to FIG. 14, the SRNC determines conversion to the USTS mode for the UE communicating on the DPCH according to a measurement report received from the UE in step 301. Conversion to the USTS mode is determined upon a request from the UE. In step 302, the SRNC transmits a Radio Link Reconfiguration Prepare message to the Node B of a corresponding cell. The Radio Link Reconfiguration Prepare message includes USTS parameters. The USTS parameters are information about a UL scrambling code, a UL channelization code, and a USTS indicator. The USTS parameters are determined by the SRNC. The operation of the method illustrated in FIG. 14 is described on the premise that the SRNC is identical to a CRNC. If the SRNC is different from the CRNC, the SRNC transmits the above information to a DRNC and the DRNC transmits the received information to the Node B. If the SRNC is different from the DRNC, the SRNC transmits only the USTS indicator information to the DRNC. Then, the DRNC determines a UL scrambling code and a UL channelization code for USTS and transmits the codes to the Node B and the SRNC. If the SRNC determines a scrambling code time offset in step 302, the SRNC transmits the determined scrambling code time offset together with USTS parameters to the Node B. For example, if the SRNC receives the PD and an RTT (Round Trip Time) from the Node B through a measurement procedure, it determines the scrambling code time offset. Time information about 256*m-chip unit synchronization and scrambling code synchronization are added to the scrambling code time offset information.

In step 303, the SRNC determines whether to transition the UE to the USTS mode by analyzing a message received from the Node B. Specifically, the SRNC determines whether a Radio Link Reconfiguration Response message including the scrambling code time offset has been received from the corresponding Node B. If the received message is not the Radio Link Reconfiguration Response message, the SRNC goes to step 306. If the received message is not the Radio Link Reconfiguration Response message, it is then a USTS conversion failure message indicating the failure of the Radio Link Reconfiguration Prepare message. In step 306, the SRNC determines that it is impossible to transition the UE to the USTS mode by the USTS conversion failure message. The USTS conversion is failed when the Node B does not support the USTS, or in the failure cases as described according to the conventional technology.

Meanwhile, if the SRNC receives the Radio Link Reconfiguration Response message from Node B in step 303, the SRNC analyses the scrambling code time offset information for USTS set in the Radio Link Reconfiguration Response message in step 304. The Radio Link Reconfiguration Response message may include the scrambling code time offset itself, or the time difference between the start point of a current received UE frame and that of a P-CCPCH frame, a value required to make the time difference equal to 256*m chips, and a PD. The PD is the mean value ½ of the value calculated by subtracting To from the difference from the start points of a corresponding DL DPCH and the UL DPCH. In addition, the Radio Link Reconfiguration Response message may include a plurality of pieces of information at the same time. While it is assumed in FIG. 14 that the SRNC is identical to the CRNC, if the SRNC is different from the CRNC, the SRNC receives the above information from the DRNC and the DRNC receives the information from the Node B. The PD in the information can be obtained from the Node B using a measurement procedure instead of receiving during the USTS mode conversion. The PD is a value resulting from the measurement procedure or from a pre-defined RRT. The RRT is defined as the difference between the start points of a corresponding DL DPCH and a UL DPCH. From the RRT, the PD=(RTT−T₀)/2 is obtained.

After analyzing the Radio Link Reconfiguration Response message, the SRNC transmits an RRC signaling message to the UE to transition to the USTS mode and then ends the procedure. A Radio Bearer Reconfiguration Prepare message, for example, is used as the RRC signaling message. The SRNC transmits time information and channel information of the UE received from the Node B, including the UL scrambling code, the UL channelization code, the USTS indicator, and the time offset using the RRC signaling message.

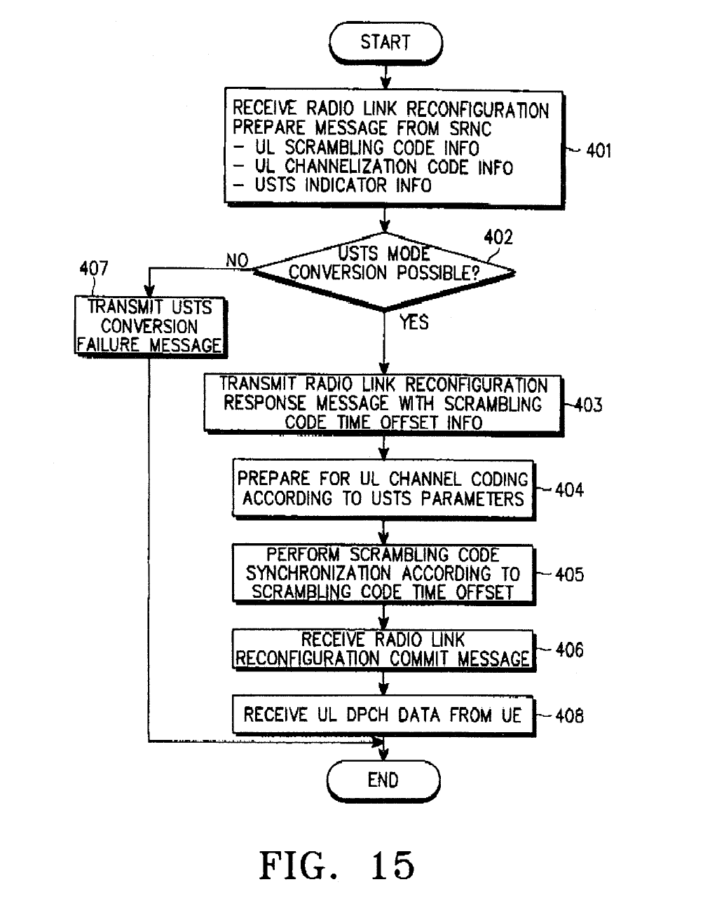

Finally, a description of the Node B during the USTS mode conversion will be given with reference to FIG. 15.

FIG. 15 is a flowchart illustrating the operation of the Node B when the UE communicating on a DPCH transitions to the USTS mode. Referring to FIG. 15, the Node B receives a USTS mode-related message from the SRNC in step 401. An NBAP message for the USTS mode conversion is, for example, the Radio Link Reconfiguration Prepare message. The received Radio Link Reconfiguration Prepare message includes information required for conversion to the USTS mode, inclusive of the UL scrambling code, the UL channelization code, and the USTS indicator.

In step 402, the Node B determines whether it is possible to transition to the USTS mode. If the USTS mode conversion is possible, the Node B goes to step 403. If the USTS mode conversion is impossible, the Node B goes to step 407.

In step 407, the Node B transmits the Radio Link Reconfiguration Failure message to the SRNC and ends the procedure.

On the other hand, if the USTS mode conversion is possible, the Node B transmits the Radio Link Reconfiguration Response message with the scrambling code time offset information to the SRNC in step 403. The Radio Link Reconfiguration Response message may include the scrambling code time offset itself, or the time difference between the start point of a current received UE frame and that of a P-CCPCH frame, a value required to make the time difference equal to 256*m chips, and a PD. If the Node B has transmitted the PD or a related RTT to the SRNC beforehand by the measurement procedure, the SRNC may determine time information for a 256*m-chip unit synchronization or scrambling code synchronization and transmit the time information to the Node B.

The Node B prepares UL channel coding according to the scrambling code, the UL channelization code, and the USTS indicator in step 404. That is, the Node B checks the UL scrambling code, and the DPDCH and DPCCH channelization codes and prepares them. In step 405, the Node B implements the scrambling code synchronization by determining the difference between a frame start point and a scrambling code start point according to the scrambling code time offset information. The Node B shifts the scrambling code by the scrambling code time offset from the frame start point and then prepares for spreading. If the UE is the first one to use a USTS scrambling code, the scrambling code time offset is 0 and the frame start point are rendered identical to the scrambling code start point. However, if the USTS scrambling code synchronization is based on a P-CCPCH, even if the UE is the first one to use the USTS scrambling code, the scrambling code time offset may not be 0. In this case, the Node B delays the scrambling code by the scrambling code time offset and prepares to receive a UL DPCH. The scrambling code synchronization is performed in a scrambling code synchronizer in the Node B that is symmetrical in structure to its counterpart illustrated in FIG. 4. The scrambling code synchronizer in the Node B will be described later.

The Node B receives a Radio Link Reconfiguration Commit message acknowledging the USTS mode conversion from the SRNC. The Radio Link Reconfiguration Commit message has time information for the USTS mode conversion and the Node B prepares to receive a UL signal at a time indicated by the time information. In step 408, the Node B receives UL DPCH data from the UE transitioned to the USTS mode and ends the procedure.

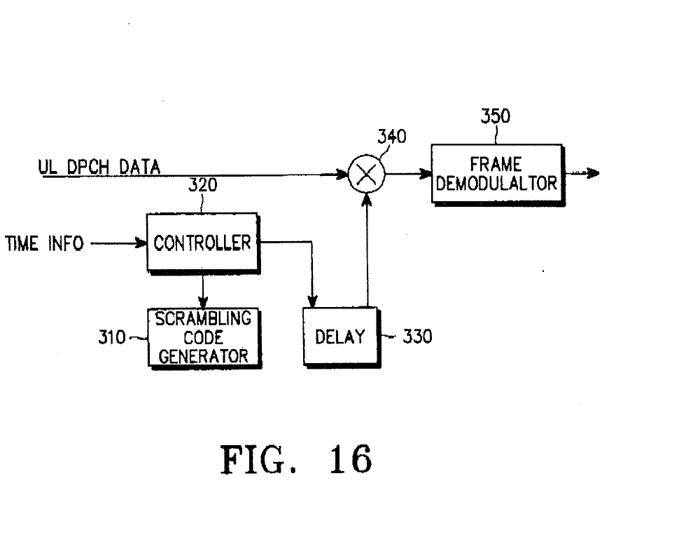

The structure of the aforementioned scrambling code synchronizer will be described with reference to FIG. 16.

FIG. 16 is a block diagram of a scrambling code synchronizer in a Node B according to the present invention. Referring to FIG. 16, a scrambling code generator 310 generates a scrambling code for a UL DPCH assigned to the UE. A controller 320 receives USTS time information of the UE and controls the scrambling code generator 310 or a delay 330 based on the difference between the start point of the received UL DPCH and a scrambling code start point. The delay 330 delays the scrambling code by a scrambling code time offset according to a time information command received from the controller 320 to make the start points of the scrambling code and a frame identical. A multiplier 340 receives the UL DPCH data and multiplies the received UL DPCH data by the scrambling code received from the delay 330. A frame demodulator 350 demodulates the data received from the multiplier 340 using a channelization code.

Next, a description will be made as to how the other UEs are assigned a scrambling code for the USTS service.

The SRNC transmits information about UL scrambling codes in use for USTS, UL DPDCH and DPCCH channelization codes, and a scrambling code start point serving as a reference time for the other UEs to the Node B. The information is transmitted by, for example, the Radio Link Reconfiguration message. The scrambling code start point information includes information for 256*m-chip unit synchronization and scrambling code synchronization. Then the Node B transmits time information measured using an established radio link, that is, a measured PD to the SRNC. The PD is calculated by subtracting Tₒ from the difference between the start points of a corresponding DL DPCH and a UL DPCH. The SRNC transmits the time information (PD) received from the Node B to the UE and the UE transmits data on the uplink for USTS according to the received time information.

When the other UEs are assigned a scrambling code for the USTS service, the UE, the SRNC, and the Node B operate as described below, in comparison with the conventional UEs.

The UE sends a request for conversion to the USTS mode to the Node B during communication over a DPCH, or the Node B attempts conversion to the USTS mode for the UE that receives a service on a DPCH only after the USTS mode. The UE transmits UL DPCH data based on a time offset for USTS in the information received from the SRNC for conversion to the USTS mode. If the time offset is 0, the UE performs the conventional DPCH operation. On the contrary, if the time offset is not 0, the UE performs synchronization by the time offset. The time offset includes information required to make the difference between the start points of a current received UE frame and a P-CCPCH frame equal to 256*m chips, that is, time information representing how much earlier or later the UE should transmit a UL DPCH with respect to the previous UL DPCH, or information about a PD generated during transmission of a UL DPCH. If the UE receives the PD, it transmits the UL DPCH earlier by a time equal to the PD.

The SRNC determines the time offset and the UE receiving the time offset transmits the UL DPCH earlier or later by the time offset. If USTS scrambling code synchronization is based on a P-CCPCH, the SRNC transmits time information for the scrambling code synchronization and the UE delays a scrambling code by the time offset prior to transmission. The scrambling code synchronization is performed by using of the scrambling code synchronizer illustrated in FIG. 4. Even if the scrambling code synchronization is based on UE time, the SRNC transmits a corresponding offset to the UE and the UE performs the scrambling code synchronization according to the received time offset.

The SRNC operates in the same manner as during the USTS mode conversion for the UE, which is first assigned a scrambling code for the USTS service. Therefore, a description of the operation of the SRNC will be omitted.

The Node B also operates in the same manner as when the UE is first assigned a scrambling code for the USTS service, except that it transmits different information in step 402 of FIG. 15.

In step 402, the Node B notifies the SRNC whether it will support the USTS mode conversion by a response message. Here, the Node B transmits the scrambling code time offset to the SRNC.

To supply information about the scrambling code time offset, the Node B selectively transmits one of the time difference between the start points of a current received UE frame and a P-CCPCH frame, a value required to make the time difference equal to 256*m chips, a PD, and the time difference between the start points of a scrambling code and a corresponding frame. When the UE is first assigned a scrambling code for the USTS service, there is no scrambling code serving as a reference, whereas when other UEs are operating in the USTS mode, the start point of the scrambling code in use for the UEs serves as a reference point. Therefore, a scrambling code offset is generated with respect to the scrambling code start point.

When a target cell does not support a handover for the USTS service, the SRNC and the UE operate as follows.

In this case, the SRNC discontinues the USTS service based on a measurement report received from the UE and prepares to establish a radio link with the new cell by the Radio Link Setup procedure or the Radio Link Addition procedure. Here, the SRNC converts the USTS mode to the normal mode for the UE by the Radio Link Reconfiguration procedure. The SRNC transmits the Active Set Update message or the Radio Bearer Reconfiguration message to notify the UE of the mode conversion procedure.

That is, the UE that was receiving the USTS service implements a handover in the following way.

After transmitting the Radio Link Setup Response message to the RNC or Node B of the new cell, the SRNC receives a response message from the RNC or Node B. If the SRNC receives information representing that the new cell does not support the USTS service by the response message, or has the information beforehand, it transmits the Radio Link Reconfiguration Prepare message to the Node B or RNC of an existing cell (one ore more radio links may exist) to convert the USTS mode to the normal mode for the UE. Then, the SRNC discontinues the USTS service for the UE and transmits a message for a typical DPCH service, for example, the Radio Bearer Reconfiguration signaling message. Signaling messages transmitted in the above second and third steps include time parameters or separate signaling messages indicating time, so that the UE and each cell discontinue the USTS at the same time and use DPCHs.

If the UE that was using the USTS is to establish a new radio link in a handover area, the SRNC transmits the Radio Link Setup Response message or the Radio Link Addition Request message to a corresponding RNC or Node B. Upon receipt of the request message, the DRNC or Node B can transmit a response message to notify whether it supports the handover or not. The response message is the Radio Link Setup Response message or the Radio Link Addition response message, as given in Table 4 below.

TABLE 4

| | | | IE type | | | |
|---|---|---|---|---|---|---|
| | | | and | Semantics | | Assigned |
| IE/Group Name | Presence | Range | reference | description | Criticality | Criticality |
| Message Discriminator | M | | 9.2.1.45 | | | |
| Message Type | M | | 9.2.1.46 | | YES | Reject |
| CRNC | M | | 9.2.1.18 | | YES | ignore |
| Communication | | | | | | |
| Context ID | | | | | | |
| Transaction ID | M | | 9.2.1.62 | | | |
| Node B | M | | 9.2.1.48 | The | YES | ignore |
| Communication | | | | reserved | | |
| Context ID | | | | value All | | |
| | | | | NBCC | | |
| | | | | shall not | | |
| | | | | be used. | | |
| Communication | M | | 9.2.1.15 | | YES | ignore |
| Control Port ID | | | | | | |
| RL Information | | 1 to | | | EACH | ignore |
| Response | | <maxnoofRLs> | | | | |
| >RL ID | M | | 9.2.1.53 | | | |
| >RL Set ID | M | | 9.2.2.39 | | | |
| >UL interference | M | | 9.2.1.67 | | | |
| level | | | | | | |
| >Diversity Indication | C- | | 9.2.2.8 | | | |
| | NotFirstRL | | | | | |
| >CHOICE diversity> | | | | | | |
| Indication | | | | | | |
| >>Combining | | | | | YES | ignore |
| >>>RL ID | M | | 9.2.1.53 | Reference | | |
| | | | | RL ID for | | |
| | | | | the | | |
| | | | | combining | | |
| >>Non Combining | | | | | YES | Ignore |
| or First RL | | | | | | |
| >>>DCH | | 0 to | | Only one | | |
| Information | | <maxnoofDCHs> | | DCH per | | |
| Response | | | | set of | | |
| | | | | coordinated | | |
| | | | | DCH | | |
| | | | | shall be | | |
| | | | | included | | |
| >>>>DCH ID | M | | 9.2.1.20 | | | |
| >>>>Binding ID | M | | 9.2.1.4 | | | |
| >>>>Transport Layer | M | | 9.2.1.63 | | | |
| Address | | | | | | |
| >DSCH | | 0 to | | | GLOBAL | ignore |
| Information | | <NumofDSCH> | | | | |
| Response | | | | | | |
| >>DSCH ID | M | | 9.2.1.27 | | | |
| >>Binding ID | M | | 9.2.1.4 | | | |
| >>Transport Layer | M | | 9.2.1.63 | | | |
| Address | | | | | | |
| >SSDT Support | M | | 9.2.2.46 | | | |
| Indicator | | | | | | |
| >USTS Support | C- | | | | | |
| Indicator | USTS | | | | | |
| Criticality | O | | 9.2.1.17 | | YES | ignore |
| diagnostics | | | | | | |

In Table 4, a USTS Support Indicator indicates whether cells in a corresponding Node B support the USTS service or not. The USTS Support Indicator is conditional because it is transmitted only when the SRNC sends a USTS handover request to the Node B. If the Node B transmits information indicating whether it supports the USTS service regardless of a request from the SRNC, C-USTS is replaced with an M (Mandatory) parameter.

Another embodiment of the present invention provides rapid initial synchronization through a tracking process. In a general mobile communication system, the tracking process is performed once over two frames. That is, when a remainder obtained by dividing a CFN (Connection Frame Number) value by 2 is 0, the last TPC bits of the frames are used for the tracking process. The CFN value represents a sequential number of the frames.

Therefore, in the case of a (¼)-chip unit tracking process, a maximum of 12 frames may be required for the initial synchronization. A delay value is notified to the Node B and the UE in a 3-chip unit, so the delay value assumed by the UE may have an error of a maximum of 1.5 chips against the actual delay value. This corresponds to the case where the delay value for the received value k is assumed to be 3*k+3/2. When the delay value for the received value k is assumed to be 3*k, the error may have a maximum of 3 chips. In the embodiment of the present invention, it will be assumed that the delay value for the received value k is presumed to be 3*k+3/2.

In this case, in order to correct an initial synchronization error of a maximum of 1.5 chips through the (¼)-chip unit tracking process, it is preferable to correct the 1.5-chip error by ¼ chip every two frames, over 12 frames. However, movement of the UE during the tracking process causes an increase in the maximum synchronization error. Therefore, the tracking process for the initial synchronization is modified as follows.

First Tracking Method

The first tracking method according to the present invention uses the last TPC bits in the first P frames for the tracking process. Unlike the conventional method where the tracking process is performed once over two frames, the first tracking method performs the tracking process once every frame for the first P frames. When P=2, the UE and the Node B perform the tracking process for the first and second frames after establishment of the DPCH. In this case, the UE and the Node do not care whether CFN of the first frame has an even number or an odd number. Therefore, when P=2, the initial synchronization is completed within a maximum of 11 frames. The initial synchronization is performed more rapidly, as the P value increases.

Since the initial synchronization is performed over a maximum of 12 frames, it is preferable that the P value is less than 12. Of course, in consideration of the mobility of the UE, it is possible to make the P value larger than 12. The P value may be either previously set by the system, or determined by the SRNC during the initial synchronization and then transmitted to the Node B and the UE using a signaling message from an upper layer. In the case of a (⅛)-chip unit tracking process, a maximum of 24 frames may be required for the initial synchronization. In this case, it is possible to minimize the time required for the initial synchronization by setting the P value to a maximum of 24. The P value is determined depending on the unit time of the tracking process.

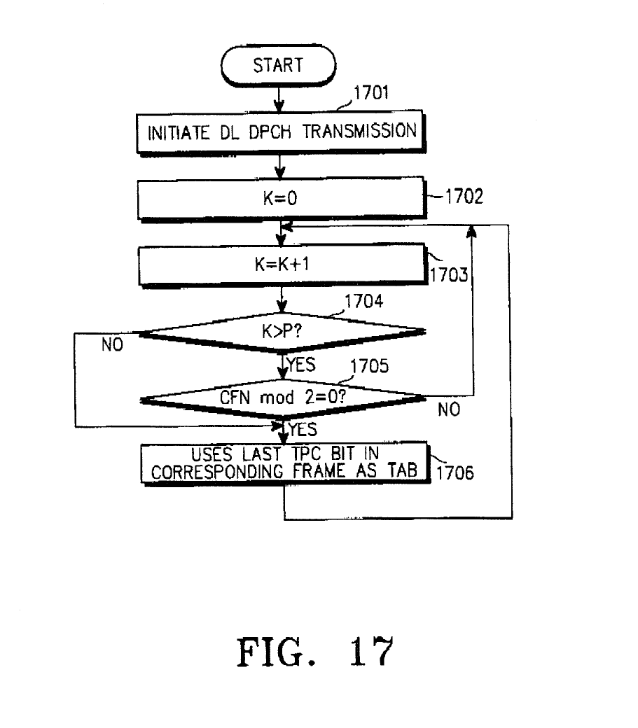

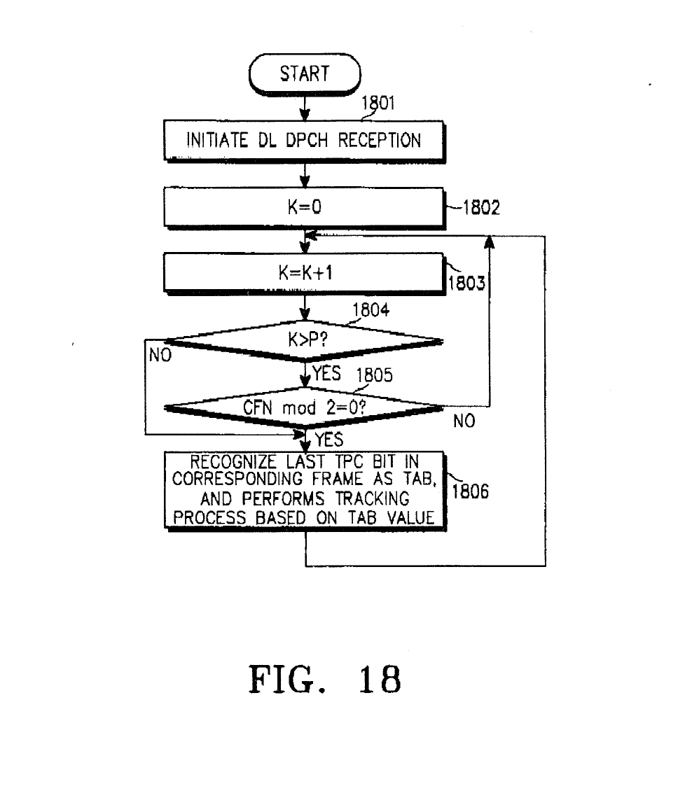

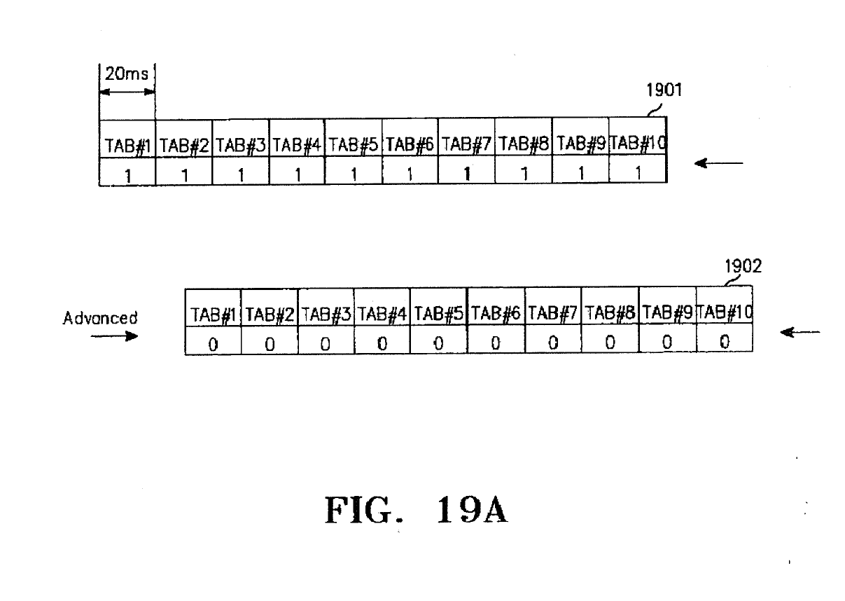

FIG. 17 illustrates an initial synchronization process performed by a Node B using a tracking process according to an embodiment of the present invention. Referring to FIG. 17, the Node B initiates DL DPCH transmission in step 1701, and at the same time, initializes a variable K, a transmission frame count value, to 0 in step 1702. The Node B increases the variable K by 1 in step 1703 (K=K+1), and compares the variable K with the P value previously set by the system in step 1704, to determine whether the variable K is larger than the P value. Here, the P value represents the number of frames set to perform the tracking in a predetermined chip unit during initial synchronization. As the result of the comparison, if the variable K is larger than the P value, the Node B determines in step 1705 whether a remainder (CFN mod 2) obtained by dividing CFN of the corresponding frame by 2 is 0. If CFN mode 2 is not 0, the Node B returns to step 1703. However, if CFN mod 2 is 0 in step 1705, the Node B proceeds to step 1706.

In step 1706, the Node B determines synchronization information using a UL DPCH signal received from the UE, and uses a TPC bit in the last slot of the corresponding frame as TAB. That is, in transmitting the frame, the Node B transmits the TAB, synchronization information, using the last TPC bit of the corresponding frame. After transmitting the frame, the Node B returns to step 1703, and repeats the above process until the DL DPCH transmission to the UE is completed.

As described in conjunction with FIG. 17, the Node B controls the UE to perform tracking in a predetermined chip unit for P-frame duration. Here, the “predetermined chip unit” may be set to a value larger than a (⅛)-chip unit, for example, set to a (¼)-chip unit. The predetermined chip unit is either previously set by the system, or determined by the SRNC during the initial synchronization. Therefore, the Node B rapidly performs the initial synchronization by performing the first tracking operation in the P-frame duration, and after a lapse of the P-frame duration, maintains the synchronization by performing a second tracking operation.

FIG. 18 illustrates an initial synchronization process performed by a UE using a tracking process according to an embodiment of the present invention. Referring to FIG. 18, the UE initiates DL DPCH reception in step 1801, and at the same time, initializes a variable K, the transmission frame count value, to 0 in step 1802. The UE increases the variable K by 1 in step 1803 (K=K+1), and compares the variable K with the predetermined value P in step 1804, to determine whether the variable K is larger than the value P. As the result of the comparison, if the variable K is less than or equal to the value P, the UE proceeds to step 1806. However, if the variable K is larger than the value P, the UE proceeds to step 1805. In step 1805, the UE determines whether a remainder (CFN mod 2) obtained by dividing CFN of the corresponding frame by 2 is 0. If CFN mode 2 is 0, the UE returns to step 1803.

However, if CFN mod 2 is not 0 in step 1805, the UE proceeds to step 1806 where it performs the tracking process using TAB included in the TPC bit of the last slot in the received DL DPCH frame. That is, based on the last TPC bit information of the corresponding frame, the UE controls a transmission time of the next UL DPCH frame in a predetermined chip unit, e.g., (¼)-chip unit or (⅛)-chip unit. After receiving the frame in step 1806, the UE returns to step 1803, and repeats the above process until the DL DPCH reception is completed.

As described in conjunction with FIG. 18, the UE performs tracking in a predetermined chip unit for P-frame duration of the DL DPCH received from the Node B. Likewise, the “predetermined chip unit” may be set to a value larger than a (⅛)-chip unit, for example, set to a (¼)-chip unit. Therefore, the UE also rapidly performs the initial synchronization by performing the first tracking operation in the P-frame duration, and after a lapse of the P-frame duration, maintains the synchronization by performing a second tracking operation.

As stated above, the first tracking method performs the tracking operation in a prescribed chip unit for the P-frame duration. Here, the chip unit is previously determined. For example, if P=6 and the prescribed chip unit is ¼, the first tracking method performs tracking every chip in a (¼)-chip unit in the 6-frame period, and after a lapse of the 6-frame duration, performs the tracking in a (⅛)-chip unit. However, it is also possible to insert a plurality of TPC bits in one frame and perform the tracking more than two times in 1-frame duration.

Herein, the first tracking method according to the present invention performs tracking once every frame. That is, the first tracking method uses the last TPC bit in one frame as TAB. Alternatively, however, in order to rapidly finish the initial synchronization, it is possible to use a plurality of TPC bits in one frame as the TABs. In this case, the TPC bits in specific positions are used as the TABs. For example, when 2 TPC bits in one 15-slot frame are used as the TABs, the TPC bits of an intermediate slot (8^{th} slot) and the last slot (15^{th} slot) in the frame are used as the TABs.

In the above case where a plurality of TPC bits in one frame are used as the TABs, the following rule is used. It will be assumed herein that 2 TPC bits in one frame are used as the TABs. In this case, if the 2 TAB bits are identical to each other, the UE performs time alignment as much as the number of chips needed for the two tracking processes during transmission of the next frame. That is, in the case of the (¼)-chip unit tracking process, the UE shifts a UL DPCH transmission point by 2/4 chip. However, if the 2 TABs are not identical to each other, the UE performs time alignment as much as the number of chips needed when the tracking process is performed based on any one of the two TABs. That is, in the case of the (¼)-chip unit tracking process, the UE shifts the UL DPCH transmission point by ¼ chip. Selecting one of the two TABs for tracking is previously determined by the system, and the tracking process is performed according to the determination. Therefore, the UTRAN performs the tracking process either once or several times using one frame.

Heretofore, a description has been made of the first tracking method where the tracking is performed in a prescribed chip unit over a prescribed number of frames. Next, a second tracking method according to an embodiment of the present invention will be described.

Second Tracking Method

In the first tracking method, the tracking unit is fixed to a prescribed chip unit. That is, if a tracking unit previously agreed between the Node B and the UE is ¼ chip, the tracking is performed in a (¼)-chip unit. However, unlike the first tracking method, the second tracking method variably sets the tracking chip unit. For example, the second tracking method sets a tracking chip unit of the first frame to a larger value and a tracking chip unit of the second frame to a smaller value.

Compared with the first tracking method, the second tracking method more rapidly acquires exact uplink synchronization by promptly correcting a synchronization error due to the propagation delay. A decrease in time required for acquiring the exact uplink synchronization contributes to an improvement in the USTS performance. Unlike the first tracking method where the tracking is performed in the fixed tracking chip unit (e.g., (¼)-chip unit or (⅛)-chip unit) according to the TABs, the second tracking method varies a synchronization time correcting unit in several initial frames, thereby rapidly acquiring the exact uplink synchronization. The second tracking method has 5 different methods of variably setting the tracking chip unit. Herein, a description of the conventional tracking method having the fixed tracking chip unit will be followed by the descriptions of the first to fifth methods. Performances of the first to fifth methods are determined by an average time required in acquiring the exact synchronization.

First, the conventional tracking method based on the fixed tracking chip unit and the uplink synchronization performance thereof will be described. The UE can recognize the propagation delay time in a 3-chip unit. In this case, the UE may use a maximum value, a minimum value or an intermediate value between them as a representative value of the tracking chip unit. First, it will be assumed that the intermediate value is used as the representative value. That is, the UE is initialized to a 0^{th} chip for the propagation delay time between 0 and 3 chips, and to a 3^{rd} chip for the propagation delay time between 3 and 6, thereby acquiring the uplink synchronization having an error within 3 chips.

In the case of the (¼)-chip unit tracking, an average initial synchronization error correcting time can be calculated through Table 5.

TABLE 5

| | | | | | | | |
|---|---|---|---|---|---|---|---|
| Initial Sync Error | 0 | 1/4 | 2/4 | 3/4 | 4/4 | 5/4 | 6/4 |
| (Chips) | | | | | | | |
| Correcting Time | 0 | 1 | 2 | 3 | 4 | 5 | 6 |
| (*2 Frames) | | | | | | | |
| Probability | 1/12 | 1/16 | 1/16 | 1/6 | 1/16 | 1/6 | 1/12 |

In Table 5, an average correcting time becomes (18/6)*2 frames. Even when the minimum value is used as the representative value, the average correcting time can be calculated as described in conjunction with Table 5. In this case, the average correcting time becomes (72/12)*2 frames.

In the case of the (⅛)-chip unit tracking, an average initial synchronization error correcting time can be calculated using Table 6.

TABLE 6

| | | | | | | | | | | | | | |
|---|---|---|---|---|---|---|---|---|---|---|---|---|---|
| Initial Sync | 0 | 1/8 | 2/8 | 3/8 | 4/8 | 5/8 | 6/8 | 7/8 | 8/8 | 9/8 | 10/8 | 11/8 | 12/8 |
| Error (Chips) | | | | | | | | | | | | | |
| Correcting | 0 | 1 | 2 | 3 | 4 | 5 | 6 | 7 | 8 | 9 | 10 | 11 | 12 |
| Time (*2 | | | | | | | | | | | | | |
| Frames) | | | | | | | | | | | | | |
| Probability | 1/24 | 1/12 | 1/12 | 1/12 | 1/12 | 1/12 | 1/12 | 1/12 | 1/12 | 1/12 | 1/12 | 1/12 | 1/24 |

In Table 6, an average correcting time becomes (72/12)*2 frames. Even when the minimum value is used as the representative value, the average correcting time can be calculated as described in conjunction with Table 6. In this case, the average correcting time becomes (288/24)*2 frames.

The conventional tracking method having the fixed tracking chip unit has been described with reference to Tables 5 and 6. Next, the first to fifth methods having a variable tracking chip unit will be described.

First Method

In the (¼)-chip unit initial tracking process, the first method corrects the uplink synchronization in a (¾)-chip unit only in the first process, and since then, corrects the uplink synchronization in a (¼)-chip unit as in the existing tracking method. For example, when an initial synchronization error is ¼chip, the uplink synchronization is acquired by first advancing an uplink transmission time by ¾ chip and then delaying the transmission time by ¼ chip twice. As a result, the uplink synchronization correcting time becomes 3*2 frames.

Shown in Table 7 are uplink synchronization correcting time values for the initial synchronization errors according to the first method.

TABLE 7

| | | | | | | | |
|---|---|---|---|---|---|---|---|
| Initial Sync Error | 0 | 1/4 | 2/4 | 3/4 | 4/4 | 5/4 | 6/4 |
| (Chips) | | | | | | | |
| Correcting Time | 4 | 3 | 2 | 1 | 2 | 3 | 4 |
| (*2 frames) | | | | | | | |
| Probability | 1/12 | 1/6 | 1/6 | 1/6 | 1/6 | 1/6 | 1/12 |

In Table 7, an average uplink synchronization correcting time becomes (15/6)*2 frames, so it is possible to acquire the uplink synchronization (3/6)*2 frames faster than the conventional tracking method. When the minimum value is used as the representative value, it is possible to correct the uplink synchronization in a (4/6)-chip unit in the first process, and since then, correct the uplink synchronization in a (¼)-chip unit. In this case, an average uplink synchronization correcting time becomes (48/12)*2 frames. That is, it is possible to acquire the uplink synchronization (24/12)*2 frames faster than the conventional tracking method.

Second Method

In the (¼)-chip unit initial tracking process, the second method corrects the uplink synchronization in a (¾)-chip unit in the first process, corrects the uplink synchronization in a (2/4)-chip unit in the second process, and then, corrects the uplink synchronization in a (¼)-chip unit as in the existing tracking method. For example, when an initial synchronization error is 2/4 chip, the uplink synchronization is acquired by first advancing an uplink transmission time by ¾ chip, delaying the transmission time by 2/4 chip, and then advancing the transmission time by ¼ chip. As a result, the uplink synchronization correcting time becomes 3*2 frames.

Shown in Table 8 are uplink synchronization correcting time values for the initial synchronization errors according to the second method.

TABLE 8

| | | | | | | | |
|---|---|---|---|---|---|---|---|
| Initial Sync Error | 0 | 1/4 | 2/4 | 3/4 | 4/4 | 5/4 | 6/4 |
| (Chips) | | | | | | | |
| Correcting Time | 3 | 2 | 3 | 4 | 3 | 2 | 3 |
| (*2 frames) | | | | | | | |
| Probability | 1/12 | 1/6 | 1/6 | 1/6 | 1/6 | 1/6 | 1/12 |

In Table 8, an average uplink synchronization correcting time becomes (17/6)*2 frames, so it is possible to acquire the uplink synchronization (⅙)*2 frames faster than the conventional tracking method. When the minimum value is used as the representative value, it is possible to correct the uplink synchronization in a (4/6)-chip unit in the first process, correct the uplink synchronization in a (¾)-chip unit, and then, correct the uplink synchronization in a (¼)-chip unit. In this case, an average uplink synchronization correcting time becomes (42/12)*2 frames. That is, it is possible to acquire the uplink synchronization (30/12)*2 frames faster than in the conventional tracking method.

Third Method

In the (⅛)-chip unit initial tracking process, the third method corrects the uplink synchronization in a (6/8)-chip unit in the first process, and then, corrects the uplink synchronization in a (⅛)-chip unit as in the existing tracking method. For example, when an initial synchronization error is ⅜ chip, the uplink synchronization is acquired by first advancing an uplink transmission time by 6/8 chip, and then delaying the transmission time by ⅛ chip three times. As a result, the uplink synchronization correcting time becomes 4*2 frames.

Shown in Table 9 are uplink synchronization correcting time values for the initial synchronization errors according to the third method.

TABLE 9

| | | | | | | | | | | | | | |
|---|---|---|---|---|---|---|---|---|---|---|---|---|---|
| Initial Sync | 0 | 1/8 | 2/8 | 3/8 | 4/8 | 5/8 | 6/8 | 7/8 | 8/8 | 9/8 | 10/8 | 11/8 | 12/8 |
| Error (Chips) | | | | | | | | | | | | | |
| Correcting | 7 | 6 | 5 | 4 | 3 | 2 | 1 | 2 | 3 | 4 | 5 | 6 | 7 |
| Time (*2 | | | | | | | | | | | | | |
| frames) | | | | | | | | | | | | | |
| Probability | 1/24 | 1/12 | 1/12 | 1/12 | 1/12 | 1/12 | 1/12 | 1/12 | 1/12 | 1/12 | 1/12 | 1/12 | 1/24 |

In Table 9, an average uplink synchronization correcting time becomes (48/12)*2 frames. In this case, it is possible to acquire the uplink synchronization (24/12)*2 frames faster than in the conventional tracking method.

Fourth Method

In the (⅛)-chip unit initial tracking process, the fourth method corrects the uplink synchronization in a (6/8)-chip unit in the first process, corrects the uplink synchronization in a (⅜)-chip unit in the second process, and then, corrects the uplink synchronization in a (⅛)-chip unit in the existing tracking method. Shown in Table 10 are uplink sychronization correcting time values for the initial synchronization errors according to the fourth method.

TABLE 10

| | | | | | | | | | | | | | |
|---|---|---|---|---|---|---|---|---|---|---|---|---|---|
| Initial Sync | 0 | 1/8 | 2/8 | 3/8 | 4/8 | 5/8 | 6/8 | 7/8 | 8/8 | 9/8 | 10/8 | 11/8 | 12/8 |
| Error (Chips) | | | | | | | | | | | | | |
| Correcting | 5 | 4 | 3 | 2 | 3 | 4 | 5 | 4 | 3 | 2 | 3 | 4 | 5 |
| Time (*2 | | | | | | | | | | | | | |
| frames) | | | | | | | | | | | | | |
| Probability | 1/24 | 1/12 | 1/12 | 1/12 | 1/12 | 1/12 | 1/12 | 1/12 | 1/12 | 1/12 | 1/12 | 1/12 | 1/24 |

In Table 10, an average uplink synchronization correcting time becomes (42/12)*2 frames. In this case, it is possible to acquire the uplink synchronization (30/12)*2 frames faster than in the conventional tracking method.

Fifth Method

In the (⅛)-chip unit initial tracking process, the fifth method corrects the uplink synchronization in a (6/8)-chip unit in the first process, corrects the uplink synchronization in a (⅜)-chip unit in the second process, corrects the uplink synchronization in a (2/8)-chip unit in the third process, and then, corrects the uplink synchronization in a (⅛)-chip unit as in the existing tracking method. Shown in Table 11 are uplink synchronization correcting time values for the initial synchronization errors according to the fifth method.

TABLE 11

| | | | | | | | | | | | | | |
|---|---|---|---|---|---|---|---|---|---|---|---|---|---|
| Initial Sync | 0 | 1/8 | 2/8 | 3/8 | 4/8 | 5/8 | 6/8 | 7/8 | 8/8 | 9/8 | 10/8 | 11/8 | 12/8 |
| Error (Chips) | | | | | | | | | | | | | |
| Correcting | 4 | 3 | 4 | 5 | 4 | 3 | 4 | 3 | 4 | 5 | 4 | 3 | 4 |
| Time (*2 | | | | | | | | | | | | | |
| frames) | | | | | | | | | | | | | |
| Probability | 1/23 | 1/12 | 1/12 | 1/12 | 1/12 | 1/12 | 1/12 | 1/12 | 1/12 | 1/12 | 1/12 | 1/12 | 1/24 |

In Table 11, an average uplink synchronization correcting time becomes (46/12)*2 frames. In this case, it is possible to acquire the uplink synchronization (26/12)*2 frames faster than in the conventional tracking method.

As described in conjunction with the first to fifth methods, the embodiment of the present invention performs the uplink synchronization correction in a variable chip rate according to circumstances in the first several processes, in order to rapidly correct the initial synchronization error caused by propagation delay. This is to properly vary the tracking chip unit according to circumstances in the first several processes in order to rapidly correct the relatively large initial synchronization error deviating from the whole tracking chip unit (e.g., 1-chip unit, (¼)-chip unit, and (⅛)-chip unit).

Also, it is possible to perform the initial synchronization more rapidly by utilizing a combined tracking method of the first tracking method and the second tracking method. This will be described with reference to FIGS. 17 and 18.

The Node B performs the procedure illustrated in FIG. 17. The Node B transmits a TAB value for (¾)-chip timing correction to the UE only when the K value is 1. The UE performs the procedure illustrated in FIG. 18. The UE performs (¾)-chip timing correction based on the TAB value only when the K value is 1. Therefore, it is possible to reduce an initial synchronization time of 1 frame.

In addition, another embodiment of the present invention provides a UE transmission time-robust control method introducing a “sliding window” concept in order to correct a tracking error caused by generation of a transmission error which may occur by transmission of the TABs.

First, the size of a basic sliding window will be defined as 200 ms, which corresponds to a 20-frame length. The defined sliding window functions as a FIFO (First-In, First-Out) queue for 10 TABs transmitted by the Node B, thereby to remove ambiguity of setting an input time period, occurring in the existing 200 ms time period setting condition. Here, although the size of the sliding window is defined as 200 ms, it can also be variably defined according to the system condition, e.g., defined as 80 ms. Further, in the conventional tracking method, an input time period for controlling the transmission time, (i.e., a period for measuring by the Node B the transmission time delay of the signal transmitted from the UE), is fixed to 200 ms, so the conventional tracking method could not properly reflect control of the transmission time. Therefore, the embodiment of the present invention adaptively varies the transmission time delay in a unit input time period in a transmission time control process, while maintaining a variable time interval (a minimum of 20 ms).

Further, in the conventional tracking method, a 200 ms input time period setting condition of the transmission time control method is unclear about designation of an initial frame in the corresponding time period, so it is difficult to set the time period. Also, it is difficult to find out relation to CFN (Connection Frame Number) comprised of 1, 2, . . . , 255. However, when introducing the sliding window concept, it is not necessary to distinguish the initial frame. Further, it is possible to adaptively vary a transmission time control interval, thus securing convenient and stable implementation.

That is, in the conventional transmission time control method, the Node B measures transmission time delay of a signal received from the UE for 200 ms, and then advances or delays a transmission interval in a (¼)-chip unit, so the transmission time control is performed even when the transmission time control is unnecessary. In the case where the UE signal received during the transmission time control closely approaches an uplink synchronization point, if the transmission time control is incorrectly performed in an opposite direction after the transmission time control is performed in a certain direction, synchronization of the signal received at the UE is unstabilized making it impossible to obtain a USTS gain. However, the novel transmission time-robust control method using combination of the 10 TABs included in the sliding window (hereinafter, referred to as (TAB combination”) according to an embodiment of the present invention provides another transmission time control function, called a “transmission time maintaining” function, in addition to the “transmission time advancing” function and the “transmission time delaying” function provided in the conventional tracking method. In addition, the transmission time-robust control method adaptively variably controls the period where the Node B measures transmission time delay of the signal received from the UE, thereby maintaining a time difference between the UE signals received from the Node B within ¼ chip, making it possible to acquire synchronization between the received UE signals and obtain a stable USTS gain through the synchronization.

Now, the transmission time-robust control method according to an embodiment of the present invention will be described on the assumption that the Node B measures transmission time delay of a signal received from the UE in a 20 ms unit which corresponds to a 2-frame length. The transmission time-robust control method is classified into a first transmission time-robust control method, a second transmission time-robust control method and a third transmission time-robust control method.

First Transmission Time-Robust Control Method

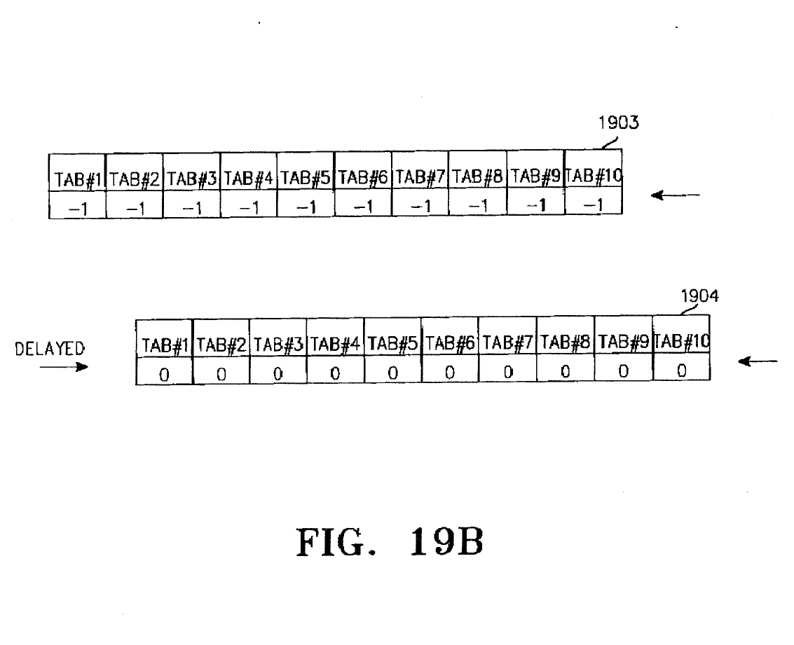

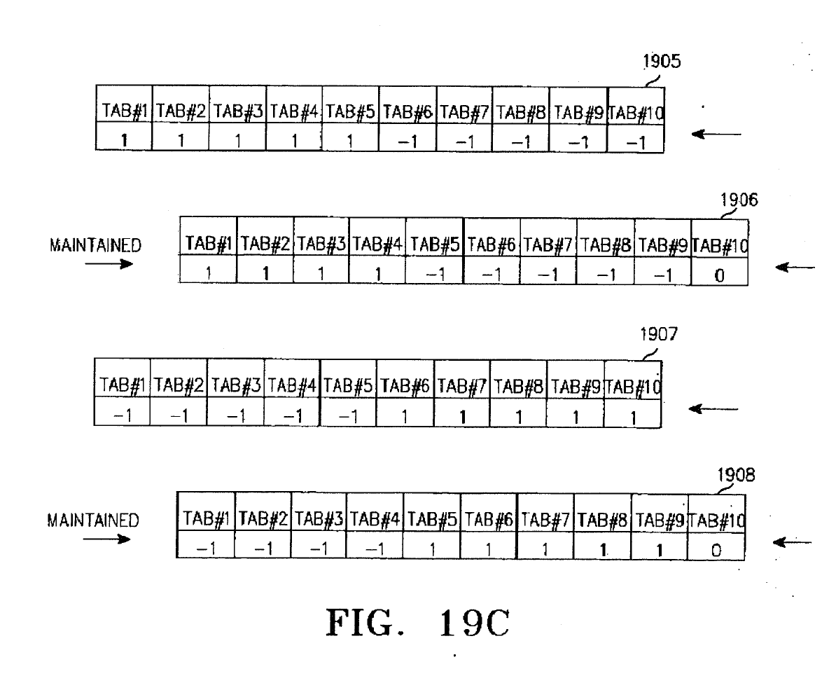

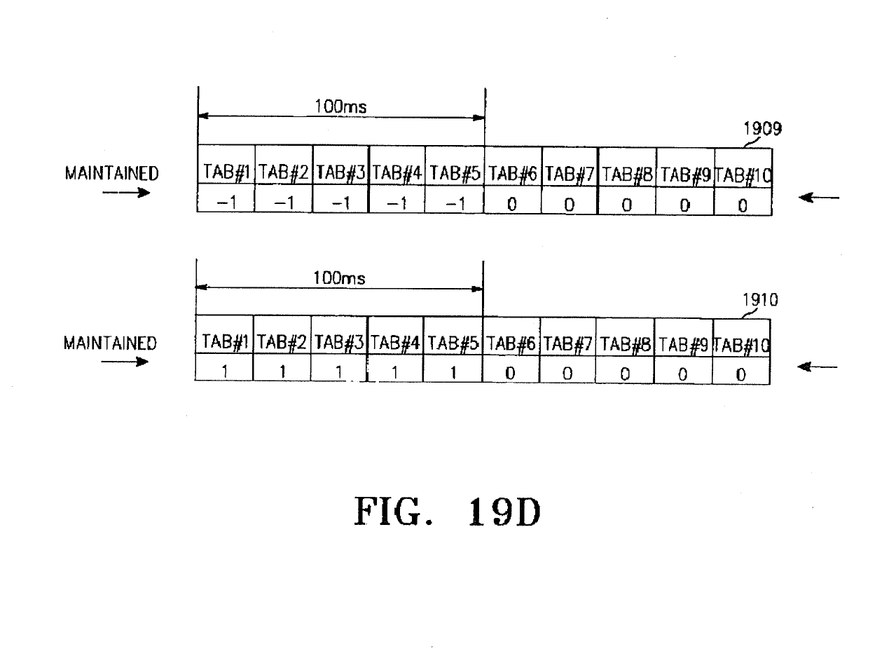

The first transmission time-robust control method will be described with reference to FIGS. 19A to 19D. FIGS. 19A to 19D illustrate a sliding window structure according to the first transmission time-robust control method. First, the Node B selectively performs transmission time-advancing control or transmission time-delaying control using the measured transmission time delay value like in the conventional tracking method. Since the Node B analyzes the measured transmission time delay value of a data frame received from the UE in a 20 ms unit, the measured transmission time delay value is updated in the 20 ms unit. Further, the Node B generates a transmission time control command by replacing the TAB corresponding to the measured transmission time delay value updated in the 20 ms unit with TPC of the corresponding frame, and then transmits the generated transmission time control command to the UE.

The UE then sequentially receives the 10 TABs in the sliding window with a size of 200 ms. Specifically, if a value of the TAB is +1, the UE advances the transmission time in a preset unit on the basis of the current transmission time. If a value of the TAB is −1, the UE delays the transmission time in a preset unit on the basis of the current transmission time. That is, the sliding window functions as a FIFO queue for the 10 TABs transmitted by the Node B. A combination of the TABs received for the sliding window is called “TAB combination”. When the TAB combination is detected as (1,1,1,1,1,1,1,1,1,1) represented by a sliding window 1901 of FIG. 19A, the UE advances the current transmission time in a (¼)-chip unit. Reference numeral 1902 represents a sliding window obtained by advancing the transmission time of the sliding window 1901. After the transmission time-advancing control, the sliding window 1902 is initialized. When the TAB combination is detected as (−1,−1,−1,−1,−1,−1,−1,−1,−1,−1) represented by a sliding window 1903 of FIG. 19B, the UE delays the current transmission time in a (¼)-chip unit. Reference numeral 1904 represents a sliding window obtained by delaying the transmission time of the sliding window 1903. After the transmission time-advancing control or the transmission time-delaying control, the UE initializes the sliding window 1902 and the sliding window 1904, and then, stores the next sliding window, (i.e., sequentially stores the 10 TABs received from the Node B for the 200 ms), thereby to prepare for transmission time control in the next period.

The transmission time-advancing control based on the TAB combination in the sliding window has been described with reference to FIG. 19A, and the transmission time-delaying control based on the TAB combination in the sliding window has been described with reference to FIG. 19B. However, when the TABs in the TAB combination of the sliding windows do not have the transmission time-advancing arrangement or the transmission time-delaying arrangement, the transmission time is controlled using the different methods of FIGS. 19A and 19B. This will be described with reference to FIG. 19C.

In FIG. 19C, a sliding window 1905 and a sliding window 1907 have TAB combination arrangements of (1,1,1,1,1,−1,−1,−1,−1,−1) and (−1,−1,−1,−1,−1,1,1,1,1) respectively. When the TAB combinations of the sliding window 1905 and the sliding window 1907 do not have a transmission time-advancing arrangement or a transmission time-delaying arrangement as stated above, the UE empties the first TAB stored in the current sliding window as illustrated by a sliding window 1906 and a sliding window 1908, (i.e., initializes the sliding widow without performing transmission time control), shifts the other TABs by one bit, and then prepares to receive the next TAB. In the case where the TAB combination does not represent the transmission time-advancing arrangement or the transmission time-delaying arrangement, a sliding window update period is set to 20 ms, when the UE empties the first TAB among the TABs of the TAB combination and sequentially advancing the other TABs.

A description of when the sliding window update period is set to 20 ms has been made with reference to FIG. 19C. Next, a description of when the sliding window update period is set to 100 ms will be made with reference to FIG. 19D. When TAB combination arrangements of a sliding window 1909 and a sliding window 1910 illustrated in FIG. 19D are detected as (1,1,1,1,1,−1,−1,−1,−1,−1) or (−1,−1,−1,−1,−1,1,1,1,1,1), 5 TABs of the TAB combination and then additionally stores 5 TABs for a ½ period (i.e., 100 ms) of another sliding window. As a result, an actual transmission time control period, (i.e., a sliding window update period), becomes 5-TAB reception time (100 ms).

As described in conjunction with reference to FIGS. 19A to 19D, the first transmission time-robust control method controls the transmission time in a sliding window update period unit, (i.e., in a 20 ms unit). Also, the first transmission time-robust control method performs transmission time-maintaining control in addition to the transmission time-advancing control and the transmission time-delaying control as in the conventional tracking method, so that the Node B stably maintains synchronization of the received UE signals within a (¼)-chip unit.

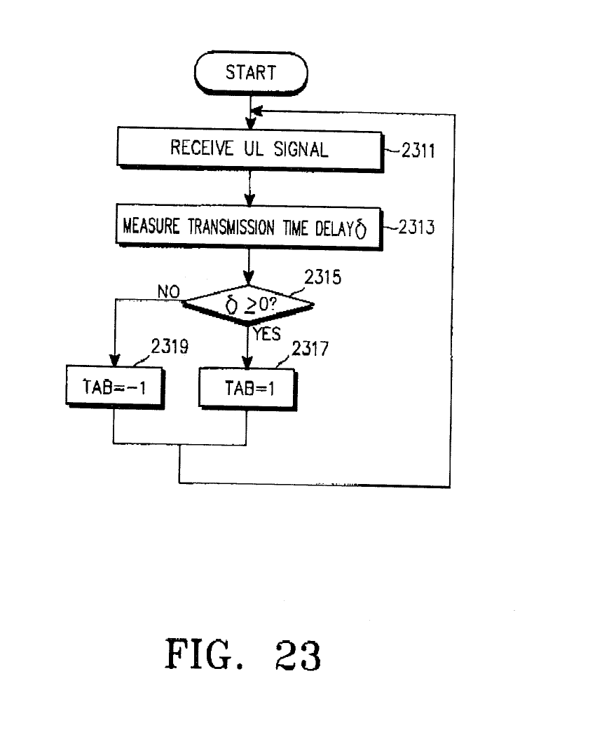

Next, a transmission time control process performed by the Node B and the UE in the first transmission time-robust control method will be described with reference to FIGS. 23 to 25.

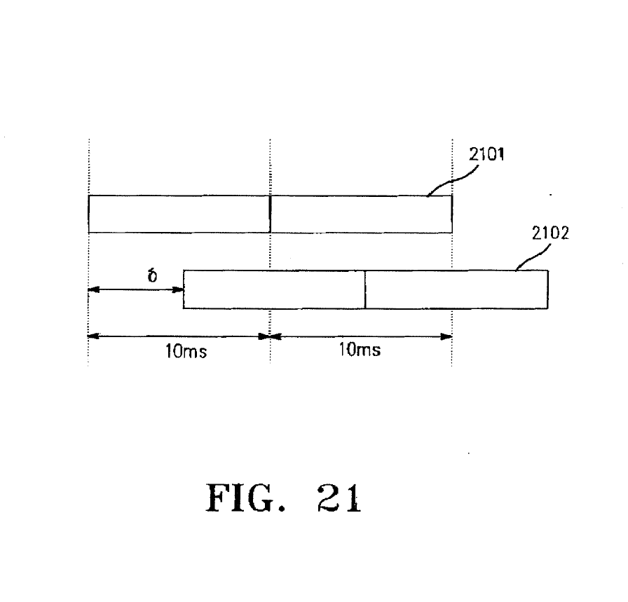

FIG. 23 illustrates a transmission time control process by the Node B according to the first transmission time-robust control method. When an agreement is previously made between the UE and the Node B during a call setup that a sliding window size shall be set to 200 ms, the Node B receives a UL signal transmitted from a corresponding UE in step 2311. Thereafter, in step 2313, the Node B measures transmission time delay δ, a difference between an expected frame reception time (reference time) 2101 and an actual frame reception time 2102 illustrated in FIG. 21. FIG. 21 schematically illustrates transmission time delay in a mobile communication system performing the USTS service. In an ideal case where no transmission time delay occurs as illustrated in FIG. 21, a frame reception time is identical to the expected frame reception time 2101. However, when transmission time delay occurs during actual frame transmission, the frame reception time is delayed by transmission time delay δ to a point 2102 from the expected frame reception time 2101. The Node B determines in step 2315 whether the measured transmission time delay δ is larger than or equal to 0 (δ≧0). That the measured transmission time delay δ is larger than or equal to 0 means that the transmission time-advancing control should be performed due to the transmission time delay as the result of comparison between the expected frame reception time 2101 and the reception time 2102 of the UL signal data frame received from the UE. In contrast, that the transmission time delay δ is less than 0 means that the transmission time-delaying control should be performed due to transmission time delay. As the result of the determination, if the measured transmission time delay δ is larger than or equal to 0, the Node B sets the TAB to 1 in step 2317 so that the UE delays the transmission time of the UL signal on the basis of the current transmission time, and transmits the set TAB to the UE. After step 2317, the Node B returns to step 2311. However, if the transmission time delay δ is less than 0 in step 2315, the Node B sets the TAB to −1 in step 2319, and transmits the set TAB to the UE. After step 2319, the Node B returns to step 2311. Here, the Node B repeats a TAB setting operation for the UL signal in a 20 ms sliding window unit.

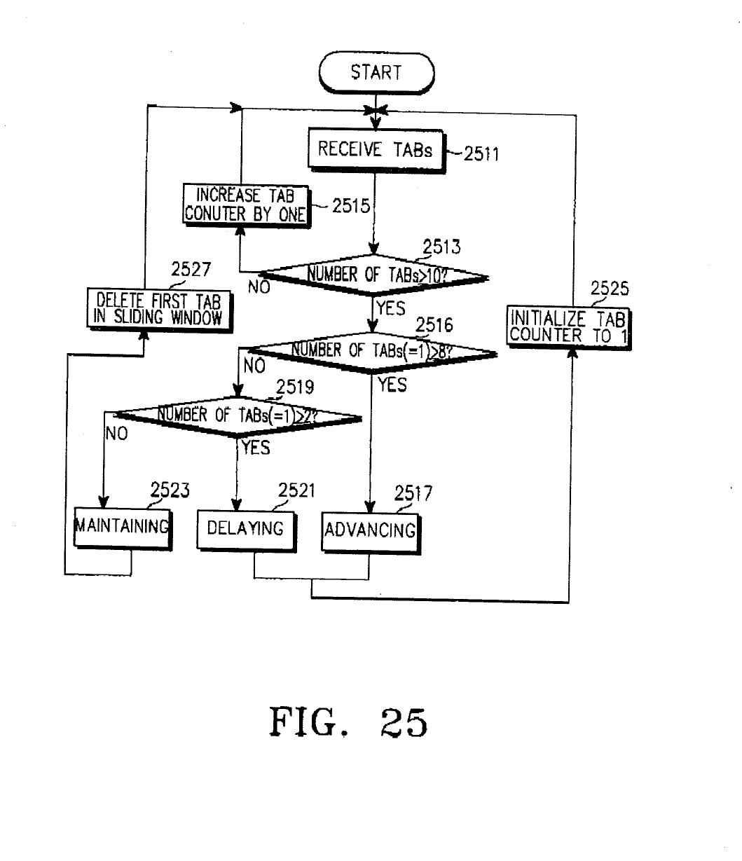

The transmission time control process by the Node B has been described with reference to FIG. 23. Next, a transmission time control process by the UE will be described with reference to FIG. 25. It will be assumed in FIG. 25 that the sliding window size is set to 200 ms.

FIG. 25 illustrates a transmission time control process by the UE according to the first transmission time-robust control method. In a state where an agreement is previously made between the UE and the Node B during a call setup that a sliding window size shall be set to 200 ms, the UE receives TABs from the Node B and stores them in a buffer in step 2511. The UE counts the number of the stored TABs in step 2513, to determine whether the number of the TABs is larger than or equal to 10. If the number of the accumulated TABs is less than 10, the UE increases a TAB counter for counting the number of TABs by one in step 2515, and then returns to step 2511 where the UE receives a new TAB from the Node B.

However, if the number of the accumulated TABs is larger than or equal to 10 in step 2513, the UE determines in step 2516 whether the number of TABs set to 1 among the 10 accumulated TABs is larger than or equal to 8. Here, that the number of the accumulated TABs is 10 means that the sliding window size is 200 ms, because it is assumed that the TAB is transmitted once every two frames. Of course, when the TAB is transmitted more frequently, the number of TABs can be larger than 10. If the number of the TABs set to 1 is larger than or equal to 8, the UE advances the current transmission time of the UL signal in step 2517, and then proceeds to step 2525. However, if the number of the TABs set to 1 is less than 8 in step 2515, the UE determines in step 2519 whether the number of TABs set to 1 is less than 2. When the number of the TABs set to 1 is less than 2, the UE delays the current transmission time of the UL signal in step 2521, and then proceeds to step 2525. In step 2525, the UE initializes the TAB counter to 1 for transmission time control in the next period, and then returns to step 2511. In this case, an operation of the sliding window is the same as described with reference to FIGS. 19A to 19D.

Meanwhile, if it is determined in step 2519 that the number of TABs set to 1 is larger than or equal to 2, i.e., if the number of TABs set to 1 among the 10 accumulated TABs is larger than or equal to 3 or 7, the UE maintains the current transmission time of the UL signal in step 2523, and then proceeds to step 2527. When determining to maintain the current transmission time, the UE discards the first received TAB in the sliding window in step 2527, and then returns to step 2511 where it receives another TAB and performs again the above processes for transmission time control.

Second Transmission Time-Robust Control Method

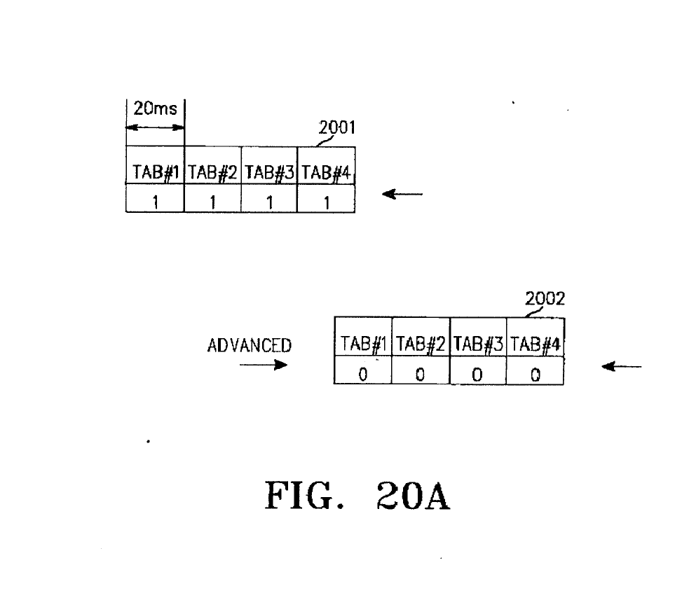

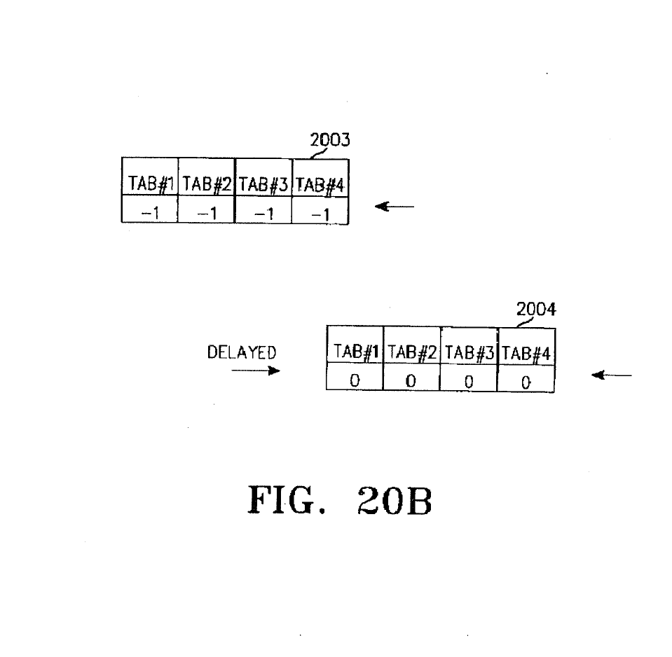

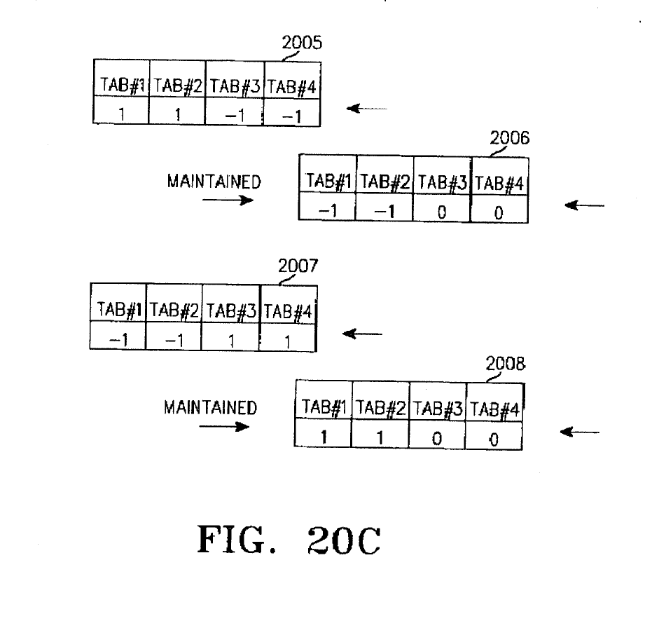

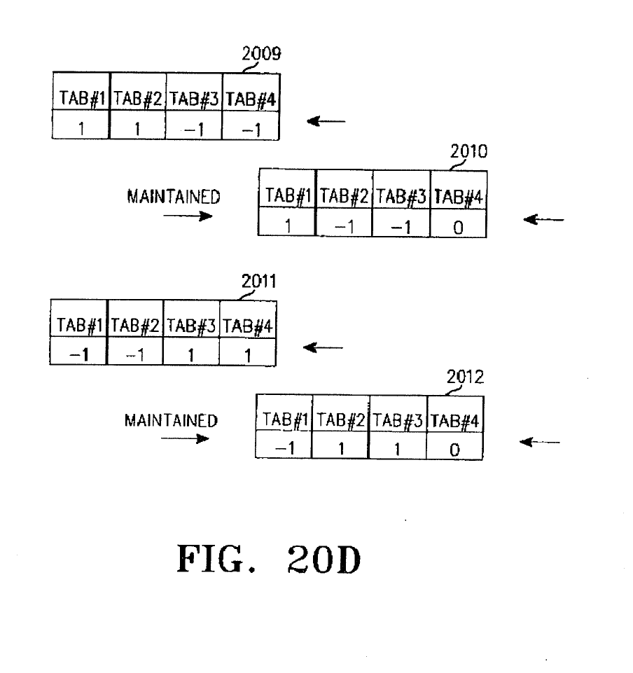

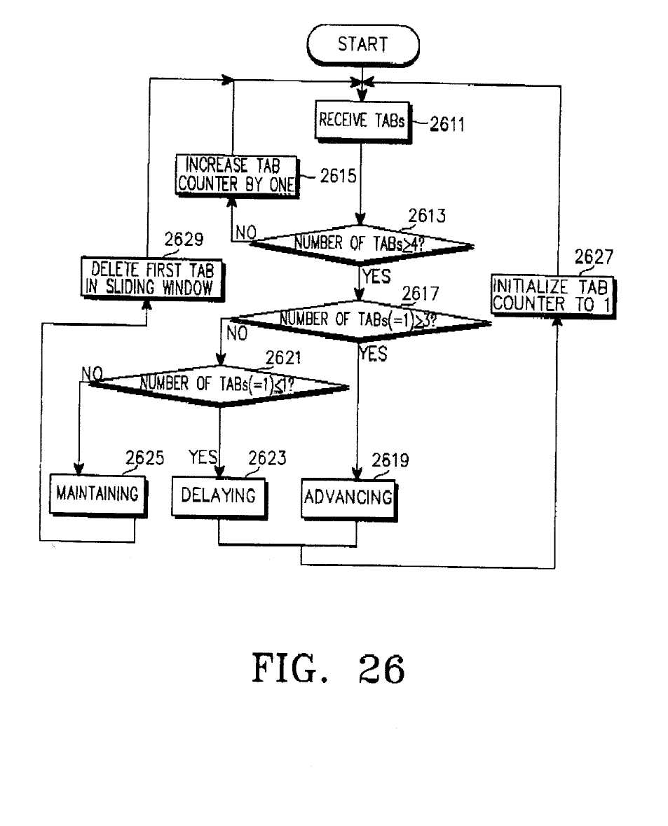

The second transmission time-robust control method will be described with reference to FIGS. 20A to 20D, and FIG. 26. FIGS. 20A to 20D illustrate a sliding window structure according to the second transmission time-robust control method. The transmission time control process of the FIGS. 20A to 20D is identical to the transmission time control process of FIGS. 19A to 19D except for the sliding window size.

As described in the first transmission time-robust control method, the Node B measures transmission time delay of the UE by analyzing a UL signal received from the UE in a 20 ms unit, and transmits a TAB based on the measured transmission time delay to the UE through TPC. It will be assumed herein that the sliding window is set to an 8-frame length, (i.e., a 80 ms length). Although a length of the sliding widow is set to 80 ms herein, it can also be set to 20 ms, 40 ms, 100 ms and 200 ms.

FIG. 26 illustrates a transmission time control process by the UE according to the second transmission time-robust control method. In a state where an agreement is previously made between the UE and the Node B during a call setup that a sliding window size shall be set to 80 ms, the UE receives TABs from the Node B and stores them in a buffer in step 2611. The UE counts the number of the accumulated TABs in step 2613, to determine whether the number of the TABs is larger than or equal to 4. If the number of the accumulated TABs is less than 4, the UE increases a TAB counter by one in step 2615, and then returns to step 2611 where the UE receives a new TAB from the Node B. However, if the number of the accumulated TABs is larger than or equal to 4 in step 2613, the UE determines in step 2617 whether the number of TABs set to 1 among the accumulated TABs is larger than or equal to 3. If the number of the TABs set to 1 is larger than or equal to 3, the UE advances the current transmission time of the UL signal in step 2619, and then proceeds to step 2627. However, if the number of the TABs set to 1 is less than 3 in step 2617, the UE determines in step 2621 whether the number of TABs set to 1 is less than 1. When the number of the TABs set to 1 is less than 1, the UE delays the current transmission time of the UL signal in step 2623, and then proceeds to step 2627. In step 2627, the UE initializes the TAB counter to 1 for transmission time control in the next period, and then returns to step 2611. In this case, an operation of the sliding window is the same as described with reference to FIGS. 20A to 20D. Meanwhile, if the number of TABs set to 1 among the 10 accumulated TABs is larger than or equal to 1 in step 2621, the UE maintains the current transmission time of the UL signal in step 2625, and then proceeds to step 2629. When determining to maintain the current transmission time, the UE discards the first received TAB in the sliding window in step 2629, and then returns to step 2611 where it receives another TAB and performs again the above processes for transmission time control. Here, an operation of the UE sliding window is the same as described with reference to FIGS. 20A to 20D.

In addition, the UE performs transmission time control by analyzing an arrangement of the TABs in the TAB combination received as much as the sliding window size illustrated in FIGS. 20A to 20D. That is, when the TABs of the TAB combination in the sliding window of the UE are arranged as (1,1,1,1) represented by a sliding window 2001 of FIG. 20A or (−1,−1,−1,−1) represented by a sliding window 2003 of FIG. 20B, the UE performs transmission time-advancing control and transmission time-delaying control on the basis of the current transmission time. However, when the TABs of the TAB combination in the sliding window of the UE are arranged as (1,1,−1,−1) represented by a sliding window 2005 of FIG. 20C or (−1,−1,1,1) represented by a sliding window 2007 of FIG. 20C, the UE maintains the current transmission time. When determining to perform the transmission time-advancing control or the transmission time-delay control, the UE initializes the whole TABs of the TAB combination in the sliding widow. However, when determining to maintain the current transmission time, the UE initializes only 2 TABs corresponding to a leading 40 ms period of the sliding window, (i.e., a leading ½ period of the sliding window), and then reconstructs an arrangement of the TAB combination in the sliding window using 2 TABs additionally transmitted for the remaining ½ period of the sliding window. Alternatively, in the case of the transmission time-maintaining control, the UE initializes only 1 TAB corresponding to a leading 20 ms period as illustrated in FIG. 20D, and then reconstructs an arrangement of the TAB combination in the sliding window using additionally transmitted 1 TAB. When the transmission time-advancing control or the transmission time-delaying control is performed to satisfy a UE's requirement that the transmission time control should be performed in a unit of a maximum of ¼ chip in a 200 ms period which is the slide window size, the UE may change the transmission time control unit to below ¼ chip. Further, when the sliding window size is set to 80 ms as illustrated in FIGS. 20A to 20D, the UE may change the transmission time control unit to below 1/10 chip.

The second tracking method is different from the first tracking method only in the sliding window size. That is, they are identical to each other in the functions performed by the Node B and the UE, and the UE is simply required to change a reference value of the TAB counter illustrated in FIG. 25 according to the slide window size. That is, for the transmission time control by the UE, the sliding window size is assumed to be 80 ms as described in conjunction with FIG. 26.

Generally, when the sliding window size is 80 ms, the maximum number of the TABs is limited to below 4. That is, when the sliding window size is 40 ms, 120 ms and 160 ms, the maximum number of the TABs is limited to below 2, 6 and 8, respectively. Of course, when a TAB transmission unit is not 2 frames (20 ms), it is possible to freely vary the number of the TABs in the sliding window. The second transmission time-robust control method is identical to the first transmission time-robust control method in a function of the Node B except the sliding window size.

As described in the first transmission time-robust control method and the second transmission time-robust control method, the sliding window size is not set to a fixed size, but variably set to 80 ms, 120 ms, 160 ms and 200 ms according to the system condition. A transmission time control unit T_{control} for controlling the transmission time should satisfy Equation (2).

T_{control}=W_{size}/800 ms (chips) (2)

In Equation (2), W_{size} represents a sliding window size expressed in terms of ms. For example, in the first transmission time-robust control method, W_{size}, is 200 ms, so the maximum T_{control} value becomes ¼ chip. In the second transmission time-robust control method, W_{size} is 80 ms, so the maximum T_{control} value becomes 1/10 chip.

Third Transmission Time-Robust Control Method

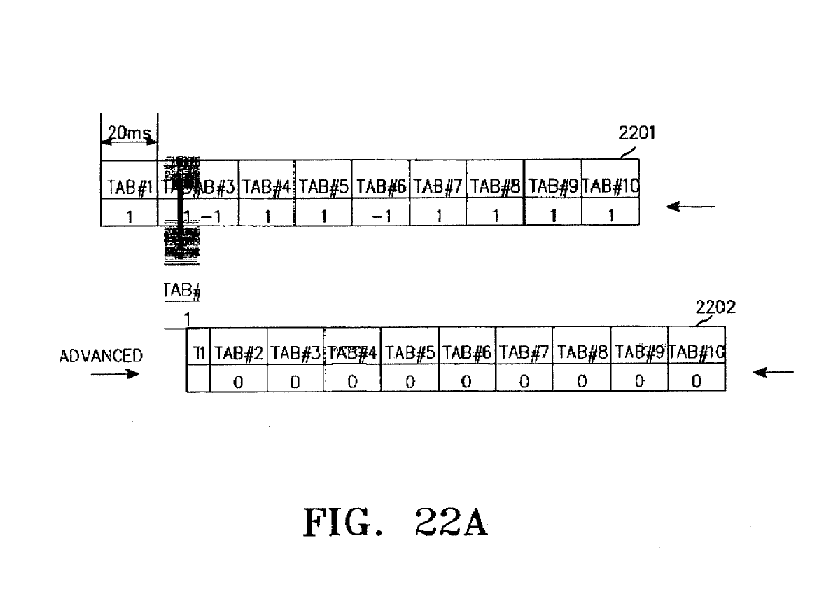

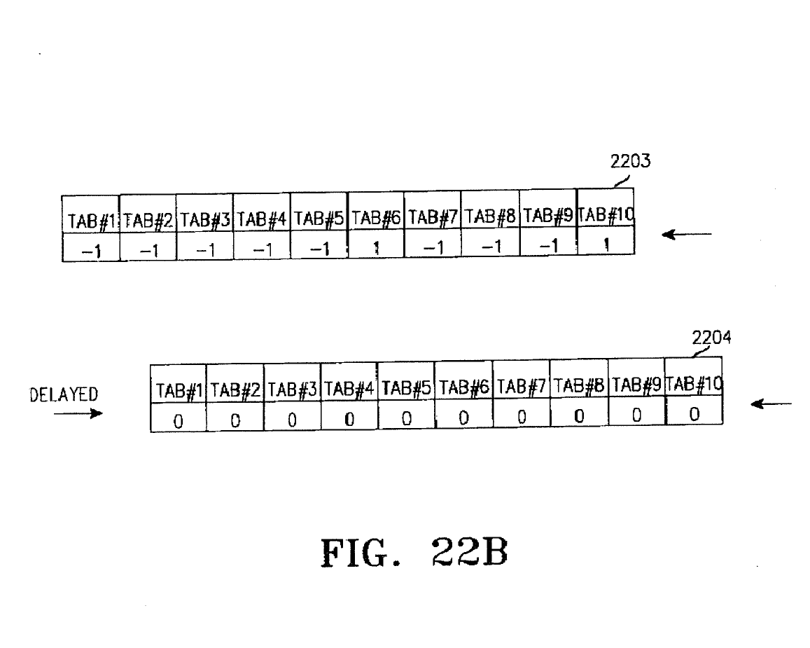

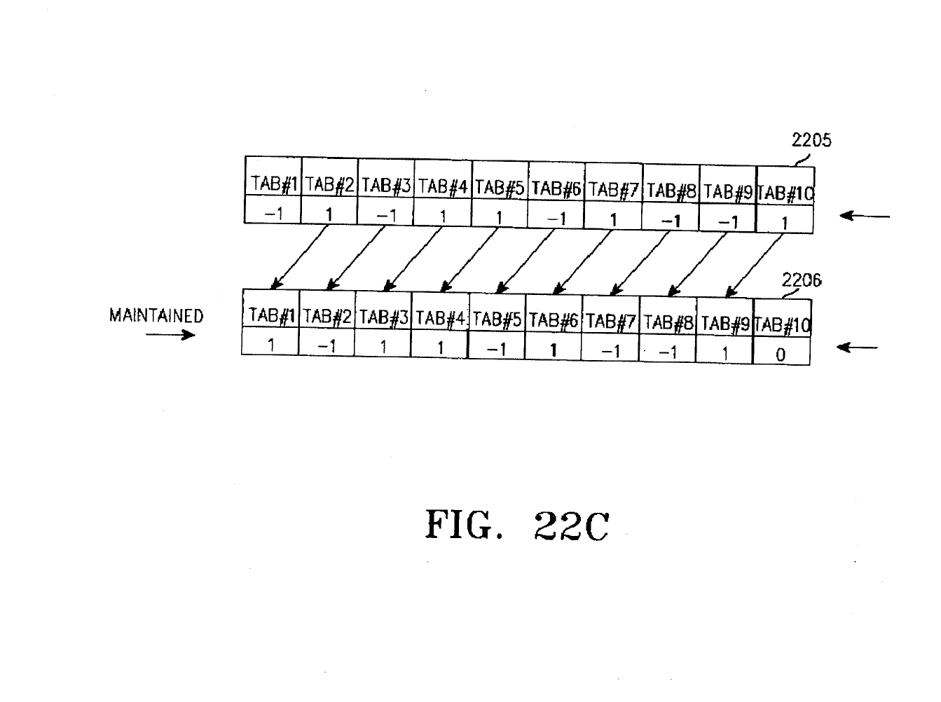

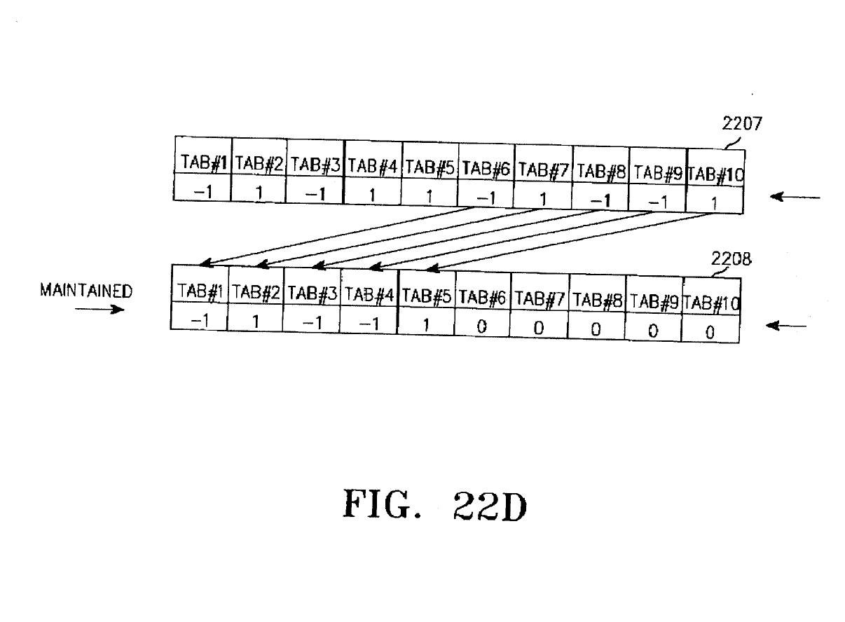

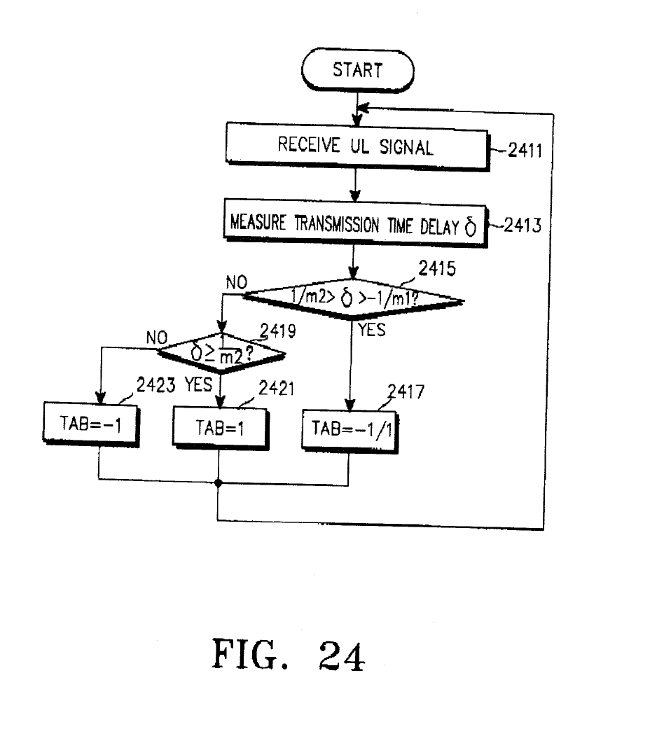

Finally, the third transmission time-robust control method will be described with reference to FIGS. 22A to 22D, and FIG. 24. FIGS. 22A to 22D illustrate a sliding window structure according to the third transmission time-robust control method. FIG. 24 illustrates a transmission time control process by the Node B according to the third transmission time-robust control method.

When the number of the TABs set to 1 in the sliding widow 2201 with a size 200 ms of FIG. 22A is larger than or equal to 8, the UE maintains the current transmission time, and initializes one TAB in the sliding window 2206 of FIG. 22C to prepare to receive the next TAB. Another method for maintaining the current transmission time is to initialize at least one of the TABs initialized in the sliding window 2208 of FIG. 22D as described in the first and second transmission time-robust control methods, and prepare to receive again as many TABs as the number of the initialized TABs.

Unlike the first transmission time-robust control method and the second transmission time-robust control method, the third transmission time-robust control method controls the Node B to additionally analyze the measured transmission delay δ and retransmit to the UE a transmission time control command in a predetermined pattern of the TAB arrangement, thereby to control the transmission time. That is, the Node B makes a decision whether it is preferable to perform the transmission time-maintaining control based on the measured the transmission time delay δ, in addition to the decision whether an arrival time of the UL signal goes ahead of or falls behind the reference transmission time.

Now, reference will be made to the conditions in which the Node B decides a transmission time control method depending on the transmission time delay δ.

$$\text{(1) Transmission Time-Maintaining Control}$$

$$\frac{- 1}{m1} < δ < \frac{1}{m2} \text{:} \begin{matrix}TAB = - 1 when CFN mod 4 = 0 or 1 \\ TAB = 1 when CFN mod 4 = 2 Or 3\end{matrix}$$

Here, the sliding window size of the Node B is assumed to be 40 ms, so the ‘CFN mod’ operation may be changed depending on a given condition.

$$\text{(2) Transmission Time-Advancing Control}$$

$$δ \geq \frac{1}{m2} \text{:} TAB = 1$$

$$\text{(3) Transmission Time-Delaying Control}$$

$$δ \leq \frac{- 1}{m1} \text{:} TAB = - 1$$

In the above three conditions for the transmission time-maintaining control, the transmission time-advancing control and the transmission time-delaying control, the transmission time delay δ means a difference between the expected frame reception time (reference time) 2101 of the UL signal from the UE and the actual frame reception time 2102 of the UL signal, as described in conjunction with FIG. 21. Further, m1 and m2 are previously determined by the system according to the system condition. For example, m1 and m2 are set to 4, 8 or 16. Herein, −1/ml is defined as a first set value (or a lower limit value), and 1/m2 is defined as a second set value (or an upper limit value).

After the Node B determines the first set value and the second set value for transmission time control, the UE performs transmission time control using an arrangement (or TAB combination) of the TABs received for the preset sliding window. Here, the number of the TABs in the TAB combination depends upon the sliding window size of the UE. In the third transmission time-robust control method, the sliding window size is set to a 20-frame period (200 ms), so the number of the TABs constituting the TAB combination is 10. Of course, like the second transmission time-robust control method, the third transmission time-robust control method can also be applied even when the sliding window size is less than 200 ms.

Next, an example of the conditions for the transmission time control of the UE will be described.

(1) Transmission Time-Maintaining Control

The transmission time-maintaining control is performed when the number of TABs set to 1 (or −1) in the sliding window is larger than or equal to 3, and less than 7.

(2) Transmission Time-Advancing Control

The transmission time-advancing control is performed when the number of TABs set to 1 (or −1) in the sliding window is larger than or equal to 8 and the number of TABs set to −1 is less than 2.

(3) Transmission Time-Delaying Control

The transmission time-delaying control is performed when the number of TABs set to 1 (or −1) in the sliding window is larger than or equal to 2 and the number of TABs set to −1 is less than 8.

When the above conditions for the transmission time control of the Node B and the UE are satisfied, a less-than-2-TAB error occurring while on the transmission time control has error recovery, thus making it possible to show a stable setting characteristic even in the disturbance-existing transmission environment.

In the third transmission time-robust control method, in addition to the transmission time-advancing control or the transmission time-delaying control, the Node B sets a third state variable for transmission time-maintaining control, and transmits the third state variable to the UE using the TAB arrangement previously agreed with the UE. The UE then controls the transmission time. This will be described with reference to FIG. 24.

After making an agreement with the UE on the sliding window size and a TAB sequence pattern for the transmission time-advancing control, the transmission time-delaying control and the transmission time-maintaining control in a state where the sliding widow size is assumed to be 80 ms, the Node B receives a data frame of a UL signal from the UE in step 2411. Thereafter, in step 2413, the Node B measures transmission time delay δ between an expected frame reception time and an actual frame reception time. The Node B determines in step 2415 whether the measured transmission time delay δ is larger than the first set value and less than the second set value. The first set value indicates a value for maintaining the current transmission time of the UE. If the measured transmission time delay δ is larger than the first set value and less than the second set value, the Node B applies a ‘CNF mode 4’ operation so as to transmit a toggled pattern of a TAB sequence (1,−1,1,−1, . . . or −1,1,−1,1, . . . ) agreed with the UE to the UE in step 2417. If the transmission time delay δ has a value between the first set value and the second set value, the Node B has 1 or −1 as the TAB value. If the condition is continuously satisfied, the Node B has a toggled value of the previous TAB value.

However, if the transmission time delay δ is not within the range between the first set value and the second set value in step 2415, the Node B determines in step 2419 whether the transmission time delay δ is larger than or equal to the second set value. If the transmission time delay δ is larger than or equal to the second set value δ≧1/m2, the Node B sets the TAB value to 1 in step 2421, and then returns to step 2411. However, if the transmission time delay δ is less than the second set value, the Node B sets the TAB value to −1 in step 2423, and then returns to step 2411. The TAB setting operation is repeated in a 20 ms unit.

As described above, the CDMA communication system using the USTS where a plurality of UEs share the same scrambling code acquires slot synchronization and frame synchronization between the UEs using the same scrambling code. The UL DPCHs received at the respective UEs have different transmission time delay values, so the UL DPCHs are misaligned. The misalignment between the UL DPCHs is controlled in an initial synchronization process. Further, the tracking method performs transmission time-maintaining control in addition to the transmission time-advancing control and the transmission time-delaying control based on reception time delay of the UE, making it possible to precisely control uplink synchronization.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for synchronizing a reception time point of an uplink dedicated physical channel (UL DPCH) signal to a expected time point when the reception time point of the UL DPCH signal received from a UE (User Equipment) is different from the expected time point by a Node B, wherein the Node B transmits a downlink dedicated physical channel (DL DPCH) to the UE at a time point assigned to the UE on a basis of a reference time point of the Node B, and the DL DPCH includes a stream of TAB (Time Alignment Bit) bits for uplink synchronization control, comprising the steps of:
measuring a difference between the reception time point of the UP DPCH and the expected time point;
transmitting information for maintaining a transmission time of the UL DPCH signal to the UE using the TAB bits, when there is a difference between a lower limit value and an upper limit value, determined by a number of the TAB bits of the DL DPCH received by the UE;
transmitting information for advancing a transmission time of the UL DPCH signal as much as a set unit determined by the number of the TAB bits, when the difference is larger than or equal to the upper limit value; and
transmitting information for delaying a transmission time of the UL DPCH signal as much as the set unit, when the difference is less than the lower limit value.

2. The method as claimed in claim 1, wherein the information for maintaining the transmission time includes toggled values of the TAB bit values of the previously transmitted DL DPCH.

3. A method for controlling a transmission time point of an uplink dedicated physical channel (UL DPCH) signal when a reception time point of the UL DPCH signal received from a UE (User Equipment) is different from a expected time point, wherein a Node B transmits a downlink dedicated physical channel (DL DPCH) signal to the UE at a time point assigned to the UE on a basis of a reference time point of the Node B, the DL DPCH signal includes a stream of TAB (Time Alignment Bit) bits for uplink synchronization control, and each of the TAB bits has a first value for advancing the transmission time point of the UL DPCH signal in a preset unit and a second value for delaying the transmission time point of the UL DPCH signal in the preset unit wherein the first and second values are determined by analyzing the reception time point of the UL DPCH signal received from the UE and transmission time delay, comprising the steps of:
receiving, at the UE, the stream of TAB bits of the DL DPCH, and advancing the transmission point of the UL DPCH in the preset unit when a number of the received TAB bits having the first value is larger than or equal to a first number;
delaying the transmission time point of the UL DPCH when the number of the received TAB bits having the first value is less than a second number; and
maintaining the transmission time point of the UL DPCH when the number of the received TAB bits having the first value is larger than or equal to the second number and less than the first number.

4. The method as claimed in claim 3, further comprising the step of deleting a first received TAB bit from the received TAB bits after maintaining the transmission time point of the UL DPCH, receiving a new TAB bit, and then updating the stream of the TAB bits.

5. The method as claimed in claim 3, further comprising the step of deleting as many consecutive TAB bits as a preset number including a first received TAB bit from the received TAB bits after maintaining the transmission time point of the UL DPCH, receiving new TAB bits, and then updating the stream of the TAB bits.

6. The method as claimed in claim 3, further comprising the step of initializing the stream of the TAB bits after advancing or delaying the transmission time point of the UL DPCH.

7. The method as claimed in claim 3, wherein the number of TAB bits constituting the stream of the TAB bits is variable.

8. A method for controlling a transmission time point of an uplink dedicated physical channel (UL DPCH) signal when a reception time point of the UL DPCH signal received from a UE (User Equipment) is different from a expected time point, wherein a Node B transmits a downlink dedicated physical channel (DL DPCH) signal to the UE at a time point assigned to the UE on a basis of a reference time point of the Node B, the DL DPCH signal includes a stream of TAB (Time Alignment Bit) bits for uplink synchronization control, and each of the TAB bits has a first value for advancing the transmission time point of the UL DPCH signal and a second value for delaying the transmission time point of the UL DPCH signal wherein the first and second values are determined by analyzing the reception time point of the UL DPCH signal received from the UE and transmission time delay, comprising the steps of:
setting a set unit, in which the transmission time point of the UL DPCH signal is advanced or delayed on the basis of a current transmission time, to a first unit when TAB bits of a first received TAB bit stream have a first value or a second value, and then setting the set unit for the transmission time point of the UL DPCH signal corresponding to the TAB bits of a next received TAB bit stream to a second unit being different from the first unit;
receiving a stream of TAB bits of the DL DPCH signal after setting the first unit, and advancing or delaying the transmission time point of the UL DPCH signal on the basis of the current transmission time in the first unit when the received TAB bits have the first value or the second value; and
after advancing or delaying the transmission time point of the UL DPCH signal in the first unit, advancing or delaying the transmission time point of the UL DPCH signal on the basis of the current transmission time in the second unit according to TAB bits in a next received stream of TAB bits.

9. The method as claimed in claim 8, wherein the number of TAB bits constituting the stream of the TAB bits is variable.
